(19) United States
(12) Patent Application Publication
(10) Pub. No.: US 2021/0352371 A1
(43) Pub. Date: Nov. 11, 2021

(54) MACHINE-LEARNING BASED SYSTEMS AND METHODS FOR ANALYZING AND DISTRIBUTING MULTIMEDIA CONTENT

(71) Applicant: Advocates Inc., Los Angeles, CA (US)

(72) Inventors: Deric Ortiz, Los Angeles, CA (US); Benjamin Dean, Los Angeles, CA (US); Pierre-Pascal Lamarche, Fredericton (CA); Matt Nishi-Broach, Mineola, NY (US)

(21) Appl. No.: 17/129,713

(22) Filed: Dec. 21, 2020

Related U.S. Application Data
(63) Continuation of application No. 16/024,511, filed on Jun. 29, 2018, now abandoned.

(51) Int. Cl. H04N 21/466; G06Q 30/02; H04N 21/478; H04N 21/234; G06N 20/00

(52) U.S. Cl. CPC H04N 21/4666; G06Q 30/0242; G06N 20/00; H04N 21/23424; H04N 21/478

(57) ABSTRACT

The present invention is directed to machine-learning based methods and systems related to dynamically inserting items multimedia content into media broadcasts. By using machine-learning based models, the performance of different items of multimedia content with different audiences can be automatically simulated, resulting in recommendations for where, when and how to optimally distribute those items of multimedia content. The multimedia content can be distributed by dynamically integrating that multimedia content into a streaming video feed. The reaction of an audience to the multimedia content is then automatically monitored, collected, and analyzed using machine-learning techniques, allowing the reaction of the audience to the multimedia content to be automatically determined. This reaction can then be input back into the machine-learning based simulator, further refining future predictions for the performance of items of multimedia content with audiences.

### FIELD OF EMBODIMENTS OF THE PRESENT INVENTION

The present invention generally relates to machine-learning based systems and methods. More particularly, embodiments of the present invention generally relate to machine-learning based systems and methods for simulating the performance of multimedia content (for example, simulating audience reaction to such content), dynamically inserting such multimedia content into media broadcasts and/or monitoring the dynamically inserted multimedia content, and/or automatically analyzing and classifying textual data related to the multimedia content.

### BACKGROUND OF THE INVENTION

In recent years, the amount of multimedia content that is generated and that is available for consumption has greatly increased. In particular, in addition to content generated by traditional mass media entities and distributed through conventional channels (for example, broadcast television or film), it has become increasingly practical for the average person to generate, distribute, and/or consume multimedia content. For example, by utilizing the increasingly diverse selection of electronic equipment (such as, for example, webcams and smartphones) available for generating content, and by utilizing social media websites and other digital platforms, nearly anyone is now capable of recording, generating, and/or broadcasting content in a diverse array of media formats.

When video content is broadcast live, it is often referred to as “live streaming” the content. For example, a growing number of individuals now live stream video feeds of themselves playing popular video or computer games. Users who create and post content are often referred to as “content creators,” and content creators who primarily live stream content are often referred to as “streamers.”

Correspondingly, just as it has become more common for individuals to generate and distribute multimedia content, it has also become increasingly accessible for others to consume that growing amount of available multimedia content. Many services exist that allow users to consume prerecorded media, ranging from content produced by high-profile companies to content produced by self-funded users. These services range from conventional multimedia distribution formats (such as, for example, traditional televised content) to newer platforms that allow individuals to both distribute and consume content. For example, services exist that allow users to generate and consume live-streamed multimedia content. Using these services, for example, individuals interested in a particular video game may watch prerecorded video posted by a content creator playing that game, or watch a streamer live stream gameplay. On other such content creation/distribution platforms, individuals may choose, for example, to watch videos generated by a content creator who shares their particular entertainment interest(s) (for example, a genre of music, television, books, or films), or to listen to podcasts created by individuals who share their political beliefs.

As individual content creators become increasingly popular, those content creators may develop a number of fans that regularly consume content created by that user, and, in some cases, “subscribe” to that user so that they receive regular notifications of new content being generated by that user. Some of these popular content creators are able to generate income from the content that they generate—for example, by attracting entities interested in reaching the content creator's audience.

Entities—for example, advertisers, charity organizations, e-sports teams, multi-channel networks (“MCNs”), or other such managers of content creators—can benefit from placing advertisements, promotions, or other content with specific content creators for several reasons. For example, the entity may seek to advertise or promote a relatively niche product, service, activity, idea, or concept that may not be appealing to the majority of the public, but may appeal to the specific audience of one or more content creators (for example, an entity may promote an improved computer graphics processor to an audience viewing a broadcast of a video game featuring complex graphics). Another example may be a situation in which it is difficult to reach the desired audience through other means (for example, because the intended audience does not typically watch cable television or subscribe to print media). When entities work with content creators, they distribute assets (pieces of multimedia content) to the content creators, which the content creators then display to visitors and their audience. E-sports teams or MCNs can also benefit from such a platform to distribute and track assets provided by their sponsors. Additionally, they can use the platform to easily distribute team branding or promotion for team-specific events such as, but not limited to, in-person meet-and-greets, matches, practice sessions, or other events.

Entities who wish to target advertisements or other promotions to the growing live-streaming market have previously been faced with two conventional options, each of which suffers from limitations and drawbacks.

One of these conventional approaches is known as the “white-glove” agency model. In this format, an entity works with a limited number of streamers or other content creators that have been hand-selected by the entity—often content creators who are already relatively popular and well-known. Working directly with a small number of streamers allows advertising or other promotion with that content creator across multiple platforms at once, but this option often means that the entity's audience is restricted to the audience of that small number of high-profile streamers—an audience which, in many cases, is shared between that small group of high-profile streamers. Consequently, limiting the distribution of advertisements and promoted material to this small group of hand-selected content creators means ignoring the cumulatively larger audience watching other mid- and upper-tier viewership streamers.

Relatively high-profile content creators may also command higher rates, meaning that the entity may reach fewer viewers with the so-called “white-glove” approach than with an aggregated group of relatively less well-known streamers. For example, if a high-profile streamer, with an audience of 1,000 people per session, charges $1,000 per session to advertise or promote, and ten lower-profile streamers with an audience of 200 people per session each charge $50 per session, the entity would reach a larger audience—at a lower price—by choosing to advertise or promote with the low-profile streamers. In conventional systems, however, the transaction costs of seeking out and reaching deals with each of those lower-profile content creators (as opposed to reaching an agreement with a single higher-profile content creator) effectively eliminates that option.

Additionally, the complications associated with manually managing an advertising or promotional campaign across multiple types of media and across multiple media distribution platforms further limits the “white-glove” approach. For example, the “white-glove” model requires monitoring that the selected content creators are in compliance with their agreed-to responsibilities as part of the advertising or promotional agreement (for example, that a streamer is displaying a required graphic on his or her video broadcast, reciting advertising or other promotional copy during an audio stream, or linking to an entity's webpage when chatting with users). Manually verifying each content creator's live streams, profile pages, and social media accounts to ensure they are in compliance with the terms of the campaign is expensive, time-consuming, and limits the ability of an advertiser or another such manager of content creators (such as, for example, an e-sports team or MCN) to scale to a large number of broadcasters.

A second conventional approach, and an alternative to the “white-glove” model, is the streaming platform partnership model. Individual platforms such as, for example, TWITCH™ and MIXER™, have their own advertising platforms, which allow potential advertisers to access a wider subset of potential content creators than through the “white-glove” agency model. However, in this approach, an advertising campaign must be conducted through that particular platform's ad system, limiting an advertiser to that individual platform instead of allowing the advertiser to conduct a campaign across multiple social media platforms (for example, simultaneously conducting an advertising campaign on the content generated by a content creator on each of TWITCH™, FACEBOOK™, TWITTER™, and YOUTUBE™).

These two conventional solutions for advertising or promoting via individual content creators also suffer from further drawbacks. For example, these conventional solutions do not currently allow entities to evaluate the advertising or promotional process as a whole by combining the different segments of the process—the selection of particular pieces of multimedia content for a campaign is disconnected from the distribution of that media to content creators (and to the audience), and is further disconnected from the evaluation of how those pieces of multimedia content performed with the audience. This disjointed approach prevents useful feedback loops and adjustments within the campaign from taking place—for example, conventional approaches do not allow for automatically promoting higher performing pieces of multimedia content while dropping poorly performing pieces of multimedia content without manual data analysis and intervention on the part of the entity.

### SUMMARY OF THE INVENTION

We have invented a system that uses machine-learning models to simulate the performance of multimedia content when distributed on different platforms (for example, to simulate the performance of advertisements displayed on a number of platforms by a number of content creators, or to simulate the performance of promotional media distributed by a particular e-sports team) and that can address the deficiencies of the above-mentioned conventional systems by automatically generating recommendations for specific, optimal ways to distribute particular pieces of media content. We have also discovered techniques for dynamically inserting such media content (for example, advertisements) directly into a multimedia stream for distribution to the audience for such content.

Further, we have invented a system that uses machine-learning methods to gather, analyze, and classify audience reactions to particular pieces of media content (such as advertisements), and allows for automatic assessment of and feedback on the performance of those pieces of media content and the performance of an advertising campaign as a whole. The machine-learning systems and methods we have invented can use this feedback to dynamically improve the machine-learning systems for simulating the performance of pieces of multimedia content.

The present invention is directed, in certain embodiments, to machine-learning based methods for simulating the performance of multimedia content. In those embodiments, the method includes receiving a first set of information describing desired performance parameters for at least one piece of multimedia content; receiving a second set of information describing characteristics of at least one platform for broadcasting multimedia content; inputting the first set of information and the second set of information into a machine learning model; generating, in the machine learning model, a recommendation of at least one piece of multimedia content to broadcast on at least one platform for broadcasting multimedia content; and receiving, from the machine learning model, the recommendation of at least one piece of multimedia content to broadcast on at least one platform for broadcasting multimedia content.

In certain embodiments, the at least one piece of multimedia content comprises at least one of a static graphic, a dynamic graphic, a webpage capture, a movie, an animation, an audiovisual stream, an audio file, a weblink, a coupon, a game, a virtual reality environment, an augmented reality environment, a mixed reality environment, and textual content.

In certain embodiments, the at least one piece of multimedia content comprises at least one promotional campaign comprised of a plurality of pieces of multimedia content.

In certain embodiments, the first set of information comprises one or more of a start date, an end date, a budget, an activity, a game, an audience interest, an asset type, a platform, and one or more desired demographics for the at least one promotional campaign.

In certain embodiments, the one or more desired demographics comprise one or more of the ages, gender, education levels, interests, income levels, occupations and geographic locations of a desired audience for the at least one promotional campaign.

In certain embodiments, the first set of information comprises goals for the at least one promotional campaign.

In certain embodiments, the goals comprise one or more of a number of audience interactions and a number of audience views.

In certain embodiments, the audience interactions comprise at least one of selecting of the plurality of pieces of multimedia content, sending a chat message, registering for an account, logging in to an account, buying a product, buying a service, giving feedback, voting, viewing an asset, playing a game, entering a code, installing software, using a website, tweeting, favoriting, adding to a list, liking a page, and visiting a web page linked to the plurality of pieces of multimedia content.

In certain embodiments, the first set of information comprises information about an entity sponsoring the at least one promotional campaign.

In certain embodiments, the information about the entity sponsoring the at least one promotional campaign comprises at least one of an industry of the entity, a type of a product being promoted, and a genre of a product being promoted.

In certain embodiments, the first set of information comprises performance data for a plurality of pieces of previously broadcast multimedia content.

In certain embodiments, the performance data comprises at least one of a number of selections of one or more of the pieces of previously broadcast multimedia content, a number of visits to web pages linked to one or more of the plurality of pieces of previously broadcast multimedia content, a number of views of one or more of the plurality of pieces of previously broadcast multimedia content, and a number of times that one or more of the plurality of pieces of previously broadcast multimedia content was liked and/or shared on one or more social media platforms.

In certain embodiments, the number of selections is at least one of a total number of selections and an average number of selections, the number of visits is at least one of a total number of visits and an average number of visits, and the number of views is at least one of a total number of views and an average number of views.

In certain embodiments, the first set of information comprises data describing one or more platforms that previously broadcast one or more pieces of multimedia content.

In certain embodiments, the one or more platforms that previously broadcast one or more pieces of multimedia content comprise one or more individuals who broadcast streaming video content, one or more individuals represented by an agency, one or more individuals representing a brand, and one or more individuals hosting a stream featuring broadcasters.

In certain embodiments, the data associated with the one or more individuals who broadcast streaming video content comprises social media statistics for the one or more individuals.

In certain embodiments, the social media statistics comprise one or more of a number of social media followers of the one or more individuals and the number of interactions with one or more social media posts by the one or more individuals.

In certain embodiments, the method further comprises collecting the social media statistics by polling social media application programming interfaces (APIs) at regular intervals.

In certain embodiments, the data associated with the one or more individuals who broadcast streaming video content comprises demographic information for an audience of the one or more individuals who broadcast streaming video content.

In certain embodiments, the demographic information comprises one or more of the ages, gender, education levels, interests, income levels, and geographic locations of the audience(s) of the one or more individuals who broadcast streaming video content.

In certain embodiments, the data associated with the one or more individuals who broadcast streaming video content comprises sentiment information for an audience of the one or more individuals who broadcast streaming video content.

In certain embodiments, the sentiment information comprises one or more reactions of the audience.

In certain embodiments, the sentiment information comprises the interest of the audience in one or more products, games, brands, companies, industries, films, songs, artists, broadcasters, players, sports, people, movies, advertisements, viewable media, and current events.

In certain embodiments, the sentiment information is gathered from machine-learning model analysis of textual data generated by the audience.

In certain embodiments, the data associated with the one or more individuals who broadcast streaming video content comprises the time periods during which the one or more individuals broadcast one or more pieces of multimedia content associated with one or more promotional campaigns.

In certain embodiments, the data associated with the one or more individuals who broadcast streaming video content comprises the budget(s) for those one or more individuals.

In certain embodiments, the method further comprises training the machine learning model by inputting performance data for a plurality of pieces of previously broadcast multimedia content and broadcaster data describing one or more platforms that previously broadcast the plurality of pieces of previously broadcast multimedia content prior to inputting the first set of information and the second set of information into the machine learning model.

In certain embodiments, the performance data and broadcaster data are contained in a feature vector.

In certain embodiments, training the machine learning model comprises using a multilayered Long Short-Term Memory (LSTM) neural network to perform a sequence-to-sequence training.

In certain embodiments, the method further comprises filtering the second set of information prior to inputting the first set of information and second set of information prior to inputting the first set of information and the second set of information into the machine learning model.

In certain embodiments, filtering the second set of information comprises eliminating one or more individuals who broadcast streaming video content from a list of potential candidates for failing to pass through at least one filter.

In certain embodiments, the at least one filter is a binary filter or a threshold filter.

In certain embodiments, inputting the first set of information and the second set of information into a machine learning model comprises creating a feature vector from the first set of information and second set of information and inputting the feature vector into the machine learning module.

In certain embodiments, generating a recommendation of at least one piece of multimedia content to broadcast on at least one platform for broadcasting multimedia content comprises generating predicted performance metrics for each of a plurality of pieces of multimedia content to be broadcast by each of a plurality of individuals who broadcast streaming video content.

In certain embodiments, the predicted performance metrics comprise performance metrics for a promotional campaign to be broadcast by each of the plurality of individuals who broadcast streaming video content.

In certain embodiments, the predicted performance metrics comprise at least one of a number of predicted selections of one or more of the pieces of previously broadcast multimedia content, a number of predicted visits to web pages linked to one or more of the plurality of pieces of previously broadcast multimedia content, a number of predicted views of one or more of the plurality of pieces of previously broadcast multimedia content, and a number of predicted times that one or more of the plurality of pieces of previously broadcast multimedia content was liked and/or shared on one or more social media platforms.

In certain embodiments, the predicted performance metrics comprise at least one of a reach score and an interactivity score for each of the of the plurality of individuals who broadcast streaming video content.

In certain embodiments, receiving the recommendation of at least one piece of multimedia content to broadcast on at least one platform for broadcasting multimedia content comprises receiving rankings of a plurality of individuals who broadcast streaming video content.

In certain embodiments, the rankings are based on a weighted average of a subset of values generated by the machine learning model.

In certain embodiments, the values comprise one or more of a broadcaster reach value, a broadcaster interactivity value, and a broadcaster affordability value.

In certain embodiments, the invention further comprises selecting one or more of the plurality of individuals who broadcast media content to broadcast at least one piece of multimedia content.

In certain embodiments, the invention further comprises the step of monitoring at least one broadcast by the selected one or more of the plurality of individuals.

In certain embodiments, the step of monitoring comprises one or more of: recording a video of a broadcast, recording screenshots of broadcast video, downloading source code from a web page, downloading one or more embedded media files from a webpage, recording a text stream, and/or recording an audio stream.

In certain embodiments, the invention further comprises the step of analyzing the at least one monitored broadcast to determine whether the at least one piece of multimedia content has been broadcast by the selected one or more of the plurality of individuals.

In certain embodiments, the step of analyzing comprises performing one or more of image recognition on one or more recorded images or videos, audio recognition on one or more recorded audio streams, and/or textual recognition on a reported text stream.

In certain embodiments, receiving the recommendation of at least one piece of multimedia content to broadcast on at least one platform for broadcasting multimedia content comprises receiving scores of a plurality of pieces of multimedia content to be broadcast.

In certain embodiments, the scores are based on a weighted average of a subset of values generated by the machine learning model.

In certain embodiments, the present invention is directed to a machine-learning system for simulating audience reaction to multimedia content. In those embodiments, the invention comprises at least one server; a first database containing information describing a plurality of pieces of multimedia content; a second database containing information describing a plurality of platforms for broadcasting multimedia content; and a machine-learning model trained to generate recommendations for one or more particular pieces of multimedia content to be broadcast by one or more particular platforms for broadcasting multimedia content, wherein the first database and second database each input information into the machine-learning model.

In certain embodiments, the first and second databases are housed on a single server.

In certain embodiments, the machine-learning model is housed on a server configured for parallel processing.

In certain embodiments, the machine-learning model is a neural network.

In certain embodiments, the neural network is a Long Short-Term Memory (LSTM) neural network or a Deep Convolutional Neural Network.

In certain embodiments, the system further comprises an Internet portal site and application programming interface (API) for entering information to be input into the first database.

In certain embodiments, the system further comprises one or more social media application programming interfaces (APIs), demographic data services, and chat applications for inputting information into the second database.

In certain embodiments, the present invention is directed to a method for dynamically inserting multimedia content into media broadcasts. In those embodiments, the method comprises creating a graphic layer that displays at least one piece of multimedia content; overlaying the graphic layer on a streaming video feed to create a aggregated display of the streaming video feed and at least one piece of multimedia content; broadcasting the aggregated display of the streaming video feed and at least one piece of multimedia content.

In certain embodiments, the at least one piece of multimedia content comprises at least one of a static graphic, a dynamic graphic, a webpage capture, a movie, an animation, an audiovisual stream, an audio file, a weblink, a coupon, a game, a virtual reality environment, an augmented reality environment, a mixed reality environment, and textual content.

In certain embodiments, overlaying the graphic layer on the streaming video feed is performed by a plugin from software used for broadcasting the aggregated display.

In certain embodiments, at least one of adding at least one more piece of multimedia content to the graphic layer, updating the at least one piece of multimedia content displayed by the graphic layer, and replacing the at least one piece of multimedia content displayed by the graphic layer with at least one different piece of multimedia content.

In certain embodiments, updating the at least one piece of multimedia content displayed by the graphic layer is triggered by an event.

In certain embodiments, the event is based on third-party data provided by a public or private API call.

In certain embodiments, the event is based on performance data associated with the broadcast of the aggregated display.

In certain embodiments, replacing the at least one piece of multimedia content with at least one different piece of multimedia content is triggered by sentiment information from an audience of the broadcast of the aggregated display.

In certain embodiments, the sentiment information is gathered from machine-learning model analysis of textual data generated by the audience.

In certain embodiments, replacing the at least one piece of multimedia content with at least one different piece of multimedia content is triggered by sentiment information from an audience of a broadcast of a different aggregated display.

In certain embodiments, the at least one piece of multimedia content is associated with a link to an Internet resource.

In certain embodiments, the link to an Internet resource is uniquely associated with at least one of the broadcaster of the aggregated display, the at least one piece of multimedia content, and the creator of the at least one piece of multimedia content.

In certain embodiments, the method further comprises recording audience member selection of the link to the Internet resource. In certain embodiments, overlaying the graphic layer on a streaming video feed comprises inserting the at least one piece of multimedia content within a virtual environment being displayed within the streaming video feed.

In certain embodiments, the present invention is directed to a machine-learning method for analyzing and classifying textual messages. In those environments, the invention comprises preprocessing at least one text stream to extract structured text units; classifying the structured text units to predict one or more of a sentiment value, activity class, and social influence score for each of the structured text units; and outputting a vector comprising the extracted predictions.

In certain embodiments, preprocessing the at least one text stream comprises one or more of tokenization, n-gram generation, hashing, and stemming.

In certain embodiments, classifying the structured text units is performed in parallel by a plurality of classifiers.

In certain embodiments, the sentiment value is a float value ranging from 0.0-1.0, and wherein 0.0 indicates an entirely negative sentiment value and 1.0 indicates a completely positive sentiment value.

In certain embodiments, the sentiment value is used to calculate a running average of the sentiment for a broadcaster associated with the at least one text stream.

In certain embodiments, the social influence score is calculated based at least in part on the social influence of a broadcaster associated with the at least one text stream.

In certain embodiments, the at least one text stream comprises a chat channel feed or a social media feed.

In certain embodiments, the method further comprises generating a report on the text stream from the vector comprising the extracted predictions.

In certain embodiments, the method further comprises analyzing a real-time stream of extracted prediction vectors to generate an anomaly score.

In certain embodiments, the anomaly score is a float value ranging from 0.0-1.0, and wherein 0.0 indicates a perfectly expected outcome and 1.0 indicates a perfectly anomalous outcome.

In certain embodiments, the method further comprises generating a real-time alert if the anomaly score is greater than a threshold value.

In certain embodiments, the anomaly score is generated using a recurrent neural network or a Hierarchical Temporal Memory/Cortical Learning Algorithm (HTM/CLA).

In certain embodiments, the invention is directed to a method of creating, executing, and evaluating an advertising campaign. In those embodiments, the method comprises creating the campaign; executing the campaign; and evaluating the campaign.

In certain embodiments, creating the campaign comprises receiving, via an application programming interface, data relating to the campaign, wherein the data comprises one or more of campaign parameters, goals for the campaign, or information relating to an advertiser; and storing the received data.

In certain embodiments, creating the campaign further comprises generating one or more predictions relating to the performance of the campaign. In certain embodiments, generating the predictions comprises inputting some or all of the received data into a machine learning model; ranking the predictions based on the received data; and selecting one or more media streamers to participate in the campaign.

In certain embodiments, executing the campaign comprises distributing pieces of multimedia content to the selected streamers and tracking the performance of the media content, the streamers, or other information.

In certain embodiments, evaluating the campaign comprises determining the response to the distributed pieces of multimedia content.

### BRIEF DESCRIPTION OF THE DRAWINGS

FIG. 1 is a flow diagram of an exemplary method for analyzing and distributing multimedia content.

FIG. 2 is a flow diagram further illustrating the steps of the method depicted in FIG. 1.

FIG. 3 is a diagram depicting the structure of an exemplary system for performing the methods depicted in FIGS. 1-2.

FIG. 4 is a diagram depicting an exemplary embodiment in which unique links for tracking an item of content are automatically generated.

FIG. 5 is a diagram depicting an exemplary embodiment of a compliance monitoring system for use with the system depicted in FIG. 2.

FIG. 6 is a diagram depicting the arrangement of an exemplary machine-learning system for evaluating the campaign.

FIG. 7 is a diagram depicting the structure of an exemplary machine-learning system for performing the evaluation of content.

FIG. 8 is a diagram depicting the structure of an exemplary neural network for implementing certain embodiments of the invention.

FIG. 9 is a diagram depicting one embodiment of the creation and use of the graphic layer of the invention.

### DETAILED DESCRIPTION OF THE INVENTION

The figures and descriptions have been provided to illustrate elements of the present invention, while eliminating, for purposes of clarity, other elements found in a typical communications system that may be desirable or required to facilitate use of certain embodiments. For example, the details of a communications infrastructure, such as the Internet, a cellular network, and/or the public-switched telephone network are not disclosed. However, because such elements are well known in the art, and because they do not facilitate a better understanding of the present invention, a discussion of such conventional elements is not included.

Embodiments of the present invention are directed to a platform that improves the distribution of multimedia content to users. In these embodiments, the invention targets two exemplary categories of users: content creators who are using the platform to distribute content to different social media and streaming platforms as well as earn money from collaborating/partnering with entities (such as, for example, brands or corporations); and entities, who are using the platform to reach their target audiences through partnerships and/or collaboration with broadcasters. These partnerships allow an entity to cause those viewing the content creator's content to experience the entity's pieces of multimedia content, thereby distributing the entity's content to the viewers of the content creators.

Each exemplary user type may have a different interaction with the embodiments of the invention disclosed herein. For the purposes of this disclosure, the “users” of the system can be, for example, entities, advertisers, team managers, MCNs, e-sports teams, system managers, or other managers of content creators. “Content creators” include, for example, broadcasters of content, such as live-streamers or media channels, and other such influencers. The term “entity” broadly includes any entity that may desire to have an audience experience its pieces of multimedia content. Thus, “entity” includes traditional companies, corporations, and other such commercial brands, but also can include sports teams, e-sports teams, MCNs, content creators, individuals, politicians, political parties, and similar such entities. For purposes of this disclosure, advertising, marketing, or promotional campaigns conducted by entities may be referred to via the term “campaign.” A campaign is made up of one or more pieces of multimedia content advertising, marketing, or promoting the entity (or one or more particular aspects or products of the entity, or a position or cause that the entity seeks to support—for example, one or more pieces of content promoting an e-sports team) behind the campaign, and may also comprise, for example, a list of one or more content creators participating in said campaign, and/or unique performance metrics such as, for example, total clicks on the pieces of multimedia content (for example, advertisements) included in the campaign, or total impressions for the campaign (or pieces of content from the campaign).

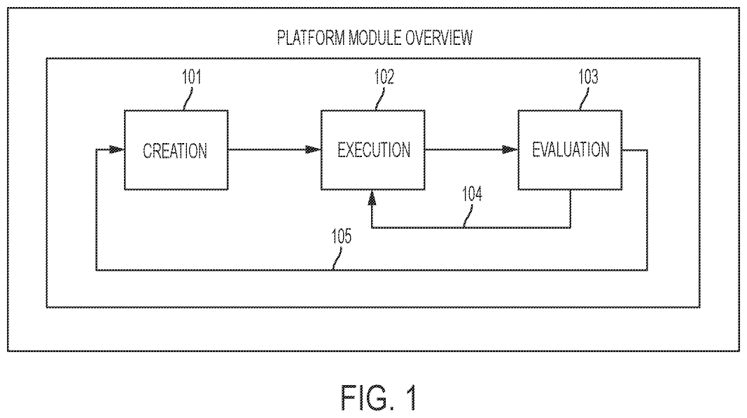

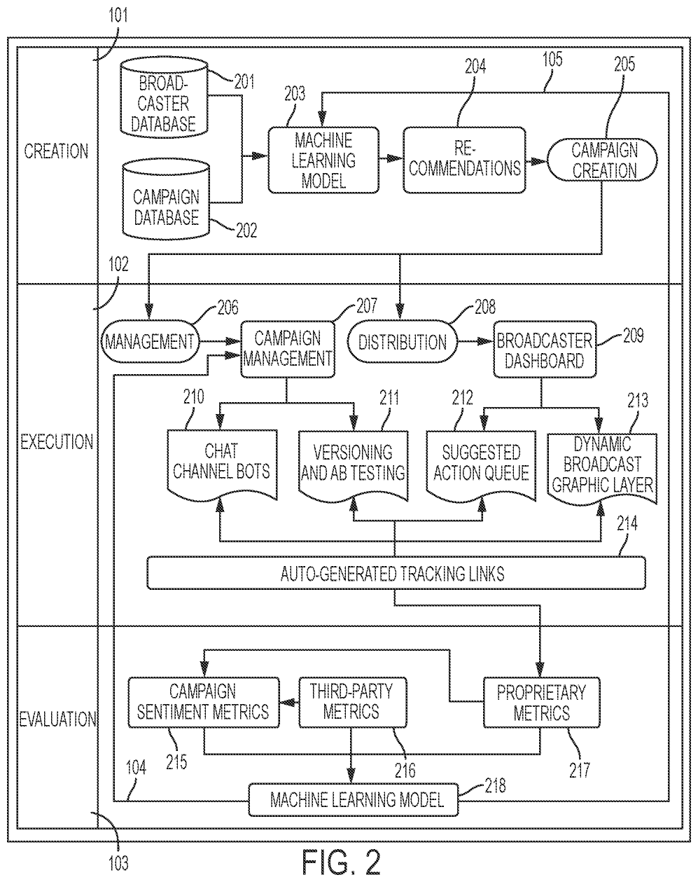

FIGS. 1-2 depict the organization of an exemplary embodiment of the invention. In this exemplary embodiment, the invention is made up of three stages. In the “Creation” stage 101, this embodiment uses existing data to compile suggestions for the campaign creation process for entities, including by performing machine-learning simulations that simulate the performance of a campaign and/or portions of that campaign. In certain embodiments, the invention can also request or generate data to compile suggestions for campaign creation during Creation stage 101. In the “Execution” stage 102, the invention involves execution, distribution and management of campaigns created during Creation stage 101. In the “Evaluation” stage 103 of this exemplary embodiment, the invention gathers data from campaign execution, third-party metrics, and proprietary metrics to provide meaningful insight through machine learning techniques. In this embodiment, the results of Evaluation stage 103 are fed back to the Creation stage 101 through link 105 and fed back to the Execution stage 102 through link 104 to create a full cycle of data analytics and recommendations, execution and evaluation.

In various exemplary embodiments of the invention, interlocking methods and systems are provided to allow entities to: (1) select a set of one or more broadcasters, target demographics, or other factors during the Creation stage 101; (2) automatically manage and distribute pieces of multimedia content across multiple social media and other platforms (e.g., TWITCH™, both in-stream and in-profile, TWITTER™, FACEBOOK™, etc.) during Execution stage 102; and (3) provide metrics to evaluate the ongoing reach and success of a campaign during Evaluation stage 103, which can then be used to refine the future creation and/or execution of such campaigns via links 104 and 105.

Embodiments of the invention can be used in any type of campaigns. For example, in some exemplary embodiments, the invention might be of particular use in a political campaign. In such an example, a political candidate could use the system to test and evaluate political messages, and determine which messages are successful on a small scale before introducing those messages to a larger audience. In other embodiments, the invention may be used in an advertising campaign. In such an example, a company could use the system to test and evaluate advertisements for the company's products or services. In another example, a news company could break news across the channels of thousands of streamers simultaneously, in real time. In another example, branding can be placed to alert an audience of an upcoming broadcast or show on a different channel with a time and date. These examples are non-limiting, and are provided only to assist with understanding of the concepts of the invention.

While the above-described embodiments are broadly characterized as comprising three distinct stages, these stages are co-dependent. For example, there may be multiple feedback mechanisms 104 from Evaluation stage 103 to Execution stage 102. For example, in embodiments of the present invention, one of the built-in tools for feedback is A/B testing on particular pieces of multimedia content. Broadly speaking, A/B testing involves testing two versions of a piece of content to see which is more successful. In this particular implementation of A/B testing, two different versions of a piece of multimedia content can be deployed, and the results compared to determine which piece of multimedia content performed better. Thus, a piece of multimedia content such as a live graphic shown during a live stream can be deployed in different versions to different broadcasters on the campaign at different times. Embodiments of the invention can recommend and automatically deploy high performing versions of the pieces of multimedia content while withdrawing lower performing versions of the pieces of multimedia content, ensuring that each piece of multimedia content is delivering its highest return on effective cost per action/acquisition (“eCPA”) (e.g., favoring pieces of multimedia content with high attribution rates) and reaching the widest possible audience (e.g., favor TWITTER™-based pieces of multimedia content with high Retweet numbers).

In the embodiment of the invention depicted in FIGS. 1-2, the Evaluation stage 103 is also important for the broadcaster recommendation system used during Creation stage 101, as in this embodiment of the invention, it is the evaluation of previous campaigns that provides the feature vector, which will be described in more detail later, for campaigns in the broadcaster-campaign recommender system. More generally, in the embodiments of the invention depicted in FIGS. 1-2, Creation stage 101, Execution stage 102, and Evaluation stage 103 are interrelated and function together to allow the invention to operate as a whole.

FIG. 2 is a diagram depicting an exemplary embodiment depicted in FIG. 1 of the invention in more detail. For example, in the embodiment of campaign Creation stage 101 depicted in FIG. 2, information regarding potential broadcasting platforms for a campaign is provided by Broadcaster Database 201, and information regarding campaigns made up of items of multimedia content (for example, an entity's desired goals or requirements for that campaign, and/or potential items of content (advertising, promotional, or otherwise) that could potentially be part of that campaign) is provided by Campaign Database 202. In this embodiment of Creation stage 101, the information from databases 201 and 202 is then input into one or more machine learning models 203, which runs simulations of potential campaigns based on the information provided by databases 201 and 202. Based on the results of those simulations, the machine learning model(s) 203 then generate(s) recommendations 204. For example, the recommendations 204 generated by machine learning model(s) 203 may include particular pieces of multimedia content that are recommended to be part of the campaign, as well as one or more broadcasting platforms that it is recommended for which the campaign should be distributed. Based on those recommendations, the manager of the campaign finalizes Campaign Creation 205 by specifying one or more factors to include in the campaign.

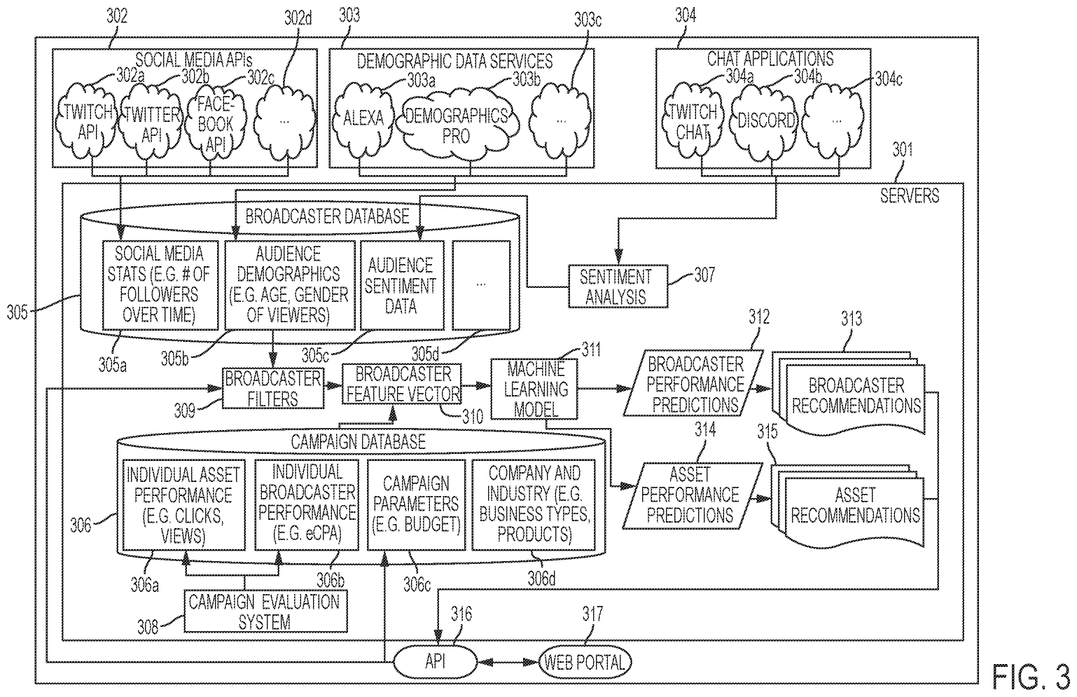

FIG. 3 is a diagram of an exemplary embodiment of a system for the campaign Creation stage 101 of the embodiments of the invention described above. The first interaction of an entity with the system will likely be through the Creation stage 101, which leverages deep-learning to help entities create the most effective campaigns according to their desired outcomes. In these embodiments, the system is able to create effective campaigns by, among other things, simulating the performance of at least one piece of multimedia content, and then make recommendations regarding the piece of multimedia content and platforms to use for distributing that multimedia content based on those simulations. The at least one piece of multimedia content can comprise at least one of a static graphic, a dynamic graphic, a webpage capture, a movie, an animation, an audiovisual stream, an audio file, a weblink, a coupon, a game, a virtual reality environment, an augmented reality environment, a mixed reality environment, and textual content. The at least one piece of multimedia content could also comprise at least one promotional campaign comprised of a plurality of pieces of multimedia content. In other embodiments, the piece of multimedia content may be comprised of several pieces of content. For example, the piece of multimedia content may comprise an image and video presented side-by-side. The pieces of multimedia content can be presented in any manner and in any combination. These examples are not limiting; the system may make a recommendation relating to any type or combination of types of multimedia content.

In certain embodiments, the one or more pieces of multimedia content may be individually editable. For example, an exemplary piece of multimedia content could be a news chryon that displays one or more scrolling (or stationary) messages (textual or otherwise), with those messages being individually editable by an entity to update the content of the news chryon to reflect breaking news and/or other events of interest to a viewing audience.

In certain embodiments, the campaign Creation stage 101 is broken down into four steps.

In an exemplary embodiment of the invention, an entity first initiates the campaign creation process via a web portal 317 and inputs data relating to the desired campaign. This includes using web forms to receive initial campaign information. During this campaign creation process, the system receives a first set of information describing desired performance parameters for at least one piece of multimedia content. The first set of information can comprise one or more of a start date, an end date, a budget, an activity, a game, an audience interest, a content type, a platform, and one or more desired demographics for the at least one promotional campaign. For example, if the entity is seeking a campaign relating to video games, the entity could indicate if they wanted to target particular game genres or games by certain publishers. If the entity is seeking to advertise a political campaign, it could seek to target a certain political belief (e.g., “pro-choice” or “pro-life”) or general political persuasion (e.g., “lean Democrat” or “lean Republican”). As another example, an entity may wish to only include certain types of content (i.e., graphics to be displayed in video streams) in the campaign instead of all possible content types. As yet another example, the entity may wish to limit the campaign to broadcasters operating on certain platforms.

The first set of information may also include goals for the at least one promotional campaign; for example, the number of desired audience interactions or a number of desired audience views for the campaign. Those interactions may comprise at least one of selecting of at least one of the pieces of multimedia content, sending a chat message, registering for an account, logging in to an account, buying a product, buying a service, giving feedback, voting, viewing an asset, playing a game, entering a code, installing software, using a website, tweeting, favoriting, adding to a list, liking a page, and visiting a web page linked to at least one of the pieces of multimedia content. Thus, for example, the entity may determine that it seeks to have a certain number of people experience the delivered multimedia content. Again, these examples are not limiting; the entity may input any information that it believes is relevant to the creation of the campaign.

The system may receive information relating to certain demographics because certain entities may attempt to appeal to only particular demographics, or may seek to determine whether pieces of multimedia content may be better received by certain demographics than by others. In certain embodiments, the one or more demographics comprise one or more of the ages, gender, education levels, interests, income levels, occupations, and geographic locations of a desired audience.

In addition to audience interaction with the campaign, the entity can designate the desired “reach” of the campaign. Reach may include the total audience that the entity seeks to have experience the at least one piece of multimedia content throughout the campaign (that is, the total number of individuals who will experience at least one piece of multimedia content), the total number of views of all of the pieces of multimedia content (including multiple experiences by individual users), or more detailed information, such as, for example, the number of individuals from each of a subset of demographic groups that the entity seeks to have experience the at least one piece of multimedia content. In one embodiment, the reach of the campaign is the total number of viewers that the entity wants to experience its campaign. In other embodiments, the reach of the campaign can be weighted or normalized, so that the entity can focus on particular platforms. For example, in that embodiment, the entity can weigh individuals who experience the campaign through FACEBOOK™ greater than those who experience the campaign through TWITTER™. Thus, the reach of the campaign may be, in that embodiment, the sum of the normalized reach of the individual broadcasters (as is explained later). The reach requirement for a campaign may be independent from the goal number of impressions for the campaign. For example, the entity may determine a campaign goal of 100,000 impressions for the campaign (i.e., that 100,000 people experience the campaign), but require that the campaign have 1,000,000 potential impressions (i.e., a campaign reach of 1,000,000). As explained previously, the entity may weigh the impressions if it values certain platforms more than others.

The entity will also generally provide information about itself, such as the industry (e.g., music, video game, telecom), business type (e.g., physical product, service, software, utility), or the type or genre of product being promoted, if any is applicable. The entity could also input any other information about the entity.

The information could also include performance data for previously-used pieces of multimedia content. In these exemplary embodiments of the present invention, the invention uses past performance to help simulate how the entity's current piece of multimedia content will perform relative to the entity's desired goals. The information relating to the previously-used content could include a number of selections of the previously-used multimedia content, a number of visits to web pages linked to one or more of the plurality of pieces of previously-used content, a number of views of those pieces of previously-used content, or a number of times that the previously-used multimedia content was reacted to (by, for example, liking, sharing, or retweeting the content). If the information includes the number of selections, it could include any of the total number of selections, visits, views, or reactions, and the average number of selections, visits, views, or reactions.

Second, after receiving the campaign information, that information is sent to the server(s). The information may be sent via an Application Programming Interface (API) 316 or through any other suitable method. In certain embodiments, this information is stored in the campaign database 306. In certain embodiments, campaign database 306 includes both the campaign information and the evaluation metrics 308 from current and previous campaigns. Although campaign database 306 is depicted as a single database, it could take any form. For example, it could be a single structure, a distributed structure, or any other suitable structure.

In addition to the campaign information, the system receives or accesses a second set of information describing characteristics of at least one platform for broadcasting multimedia content. In certain embodiments, the information comprises data describing one or more platforms that previously used one or more pieces of multimedia content. Those platforms could include, for example, individuals who broadcast streaming content, individuals represented by an agency, one or more individuals representing a brand, or one or more individuals hosting a stream featuring broadcasters. The platforms could also include platforms that host prerecorded multimedia, such as prerecorded movies, television shows, music, audiobooks, or other media. Again, these examples are not limiting; the platforms could be any, either new or previously used.

In certain embodiments, the second set of information includes information relating to the platforms. For example, the information could include social media statistics (social media followers, total number or average number of interactions with social media for the platform, total or average number of reactions from those who have experience with the platform, etc.).

Data relating to platforms and broadcasts may, in certain embodiments, be stored in broadcaster database 305. In certain embodiments, the broadcaster database 305 includes social media statistics collected from various social media APIs 302. These statistics include both user-level data (e.g., how many followers does the user have on TWITCH™) and item-level data (e.g., how many Likes and Retweets a Tweet has received, or how many viewers a TWITCH™ stream has). In some embodiments, this data is collected by polling the third-party social media APIs at regular intervals. In one embodiment of the invention, user-level data is collected daily, whereas item-level data is collected at intervals ranging from every five minutes for live-stream data (e.g., TWITCH™ and MIXER™ streams) to every hour for status updates or archived videos (e.g., YOUTUBE™ videos, FACEBOOK™ posts). The data could be determined using any method. In addition to polling social media APIs at regular intervals, the data could also be determined manually, by capturing images of the relevant webpages and extracting data, collecting the data directly, or through a custom program. This data may additionally include, for example, geolocation data derived from IP addresses, US census data, competitive gameplay statistics, and other third-party data.

In certain embodiments, the second set of information includes demographic information for an audience associated with the platforms. For example, the information could include data relating to the age, gender, education level, interests, income level, or geographic location of the audience.

In certain embodiments, the audience demographic data may be stored in broadcaster database 305. The data may be collected from a range of sources 303. Some of the demographic data may come from similar sources as the social media statistics 302. The social media statistics are focused on interaction: the “what” and “how many” of the audience, while the demographics data is focused on the “who” including information such as audience age, gender, income, etc., as explained previously. As this information tends to change more slowly than viewership numbers, in certain embodiments this information is collected less frequently than the social media statistics. In other embodiments, the information is collected with the same or similar frequency to the social media statistics.

In certain embodiments, the information relating to the platforms comprises sentiment information of an audience associated with the platforms. For example, the information could include one or more reactions of the audience. This could include reactions to the platform itself (e.g., reactions to a broadcaster), or reactions to one or more products, games, brands, companies, industries, films, songs, artists, broadcasters, players, sports, people, movies, advertisements, viewable media, or current events. The sentiment information could also include interest in one or more products, games, brands, companies, industries, films, songs, artists, broadcasters, players, sports, people, movies, advertisements, viewable media, or current events. The sentiment data could also be regarding a broad range of topics, including products and brands, pop culture artifacts (e.g., games, movies), and current events. In certain embodiments, the sentiment data is stored in broadcaster database 305.

In certain embodiments, the system can gather sentiment information from the audience. For example, the audience may generate textual data, which the system analyzes to determine the audience's sentiment. The audience may also, in other embodiments, generate visual, audio, or any other type of data, or any combination of types of data, which can then be analyze for the audience's sentiment. For example, the data could be collected from running sentiment analysis on chatroom data from chat services (e.g., TWITCH™, DISCORD™). In certain embodiments, a machine-learning model is used to analyze the data generated by the audience.

In certain embodiments, the information relating to the platforms comprises the time period during which the platforms broadcast one or more pieces of multimedia content associated with one or more promotional campaigns, Thus, the system can focus on the time period during which the platforms caused the audience to experience pieces of multimedia content in the past. Based on factors that occur during that time period, the system can then predict the outcome for other pieces of multimedia content. For example, the system can evaluate the audience sentiment as the audience experienced each piece of multimedia content, and based on that evaluation make recommendations to the entity regarding its own possible campaign.

In certain embodiments, the information relating to the platforms comprises the budgets associated with those platforms. For example, the information may include the price that a platform charges to broadcast pieces of multimedia content. This price may be per piece of multimedia content, per time period, or any other measure. By evaluating the budget for the platform, the system can evaluate and, possibly, aggregate suggested platforms so as to tailor the entity's campaign to have the maximum impact per dollar spent.

In certain embodiments, campaign database 306 contains the parameters of a given campaign. These parameters may include, for example, elements such as budget, start and end dates, and participating broadcasters. In certain embodiments, the campaign database 306 contains performance data for individual pieces of multimedia content used in the campaign. This includes, but is not limited to, data such as the number of clicks for banner advertisements, the average number of viewers for advertisements shown during a live stream, or the number of Likes, Retweets, or impression data for Tweets sent as part of the campaign.

In certain embodiments, the campaign database 306 contains performance data for individual broadcasters that participated in the campaign. This includes but is not limited to viewer numbers during broadcasters (e.g., average viewers, peak viewers, total viewer hours), social media engagements (e.g., number of Likes on FACEBOOK™ posts), and number of clicks.

In certain embodiments, the campaign database 306 may also allow data to be stored in a way that allows the viewers to be grouped by cohort. Generally, cohort analysis involves grouping users based on shared events or experiences (for example, attending a certain concert or convention, or attending a certain college). In certain embodiments, the audience of each broadcaster may be built out as its own cohort. Audiences of broadcasters with certain relevant similarities may also be aggregated into cohorts; for example, audiences of broadcasters relating to a particular game may be viewed as a single cohort. In other embodiments, both the individual audiences of each broadcaster and the aggregated audiences of several broadcasters may be viewed as cohorts for the purposes of analysis.

Third, information is run through the broadcaster and recommendation system 309-315, which in certain embodiments uses a deep-learning machine learning model to predict the performance of all potential streamers on the new campaign based on our data on the performance of broadcasters on previous campaigns.

In certain embodiments, the second set of information is filtered before the first set of information is input and before the first and second sets of information are input into the machine-learning model. For example, platforms and/or broadcasters could be eliminated from consideration by passing through a number of simple filters 309. In certain embodiments, the filters may be simple binary filters (i.e. any broadcaster that doesn't stream a given game is eliminated from consideration, or a platform that charges too much to broadcast is eliminated from consideration, or a platform whose audience does not contain a particular demographic is eliminated from consideration). In some embodiments of the invention, some of these are threshold filters (e.g., a broadcaster must have at least a certain number of average viewers to be considered, or must have completed a certain number of campaigns, or must have at least a certain compliance rate).

In certain embodiments, once the broadcasters have been filtered using the campaign parameters 307, the broadcaster feature vector 310 is constructed. This feature vector may, in certain embodiments, use and include information extracted from both the broadcaster database and campaign database to create the training data fed into the machine learning model. Each row of training data can be thought of as a pairing of a broadcaster and a campaign containing information on a broadcaster, the campaign in which the broadcaster participated, and the broadcaster's performance during that campaign. In certain embodiments, inputting the first and second sets of information into a machine-learning model comprises creating a feature vector from the two sets of information and inputting the vector into the model.

In certain embodiments, the feature vector 310 includes not only raw social media stats added to the feature vector (number of Followers), but also various deltas within the social media stats (e.g., Follower increase over the past month, or percentage of Followers gained over the past month), which could surface not just popular broadcasters but fast-rising stars.

In certain embodiments, the feature vector 310 includes the time since the broadcaster last participated in a campaign. This can help ensure that a small minority of popular broadcasters do not dominate recommendations. This may also ensure that platforms that have become inactive are no longer considered for campaigns.

In certain embodiments, the feature vector 310 includes audience sentiment towards the various products, industries, and cultural products. This can be used to match audience sentiment towards the campaign subjects. For example, if the campaign is advertising a new graphics processor, the feature vector can include sentiment towards certain companies, games, or other computer products. If it is a political campaign, the feature vector can include sentiment towards certain politicians, personalities, or issues. Thus, the information included in the vector can be tied to the type of campaign, as well as the goals of the campaign. However, the feature vector may contain also contain any other audience sentiment information.

In certain embodiments, the feature vector 310 includes information on the costs of working with the platform. In certain embodiments, this information is collected via web forms in the web portal 317 when the broadcaster initially joins the system, and can be updated via the web portal when the broadcaster updates their pricing structure. This information may also be aggregated in any number of ways, including by detecting and receiving pricing information on the platform's website, receiving information from another website, server, or database, or receiving the information from the entity (for example, if they have a previous relationship with the platform). Again, these examples are not limiting; the information may be received through any manner.

In certain embodiments, once the feature vector has been established, sets of platform/campaign pairing data can be fed into the deep-learning performance prediction system 311. When a machine-learning model is used, in certain embodiments the invention comprises training the machine-learning model. The machine-learning model can be trained by, for example, inputting performance data for a plurality of pieces of previously used multimedia content. The machine-learning can also be trained, along with the performance data for the pieces of multimedia content or separate from the performance data, by inputting platform data describing the one or more platforms that previously broadcast the pieces of multimedia content. This training can occur before the first set of information and second set of information are input into the machine-learning model, or also could occur after the information is input to the model. For example, the two sets of information could be input and stored while training occurs.

Training may occur using any method; for example, training may use a multilayered Long Short-Term Memory (“LSTM”) neural network to perform sequence-to-sequence training. In those embodiments, each input, a broadcaster/campaign feature vector, outputs a sequence of outputs (i.e. y₁, y₂, . . . yₘ) that correspond to predicted performance metrics of the broadcaster in a given campaign 312.

In some embodiments, the performance data of pieces of content and broadcasters from previous campaigns is used as “labeled” data (i.e., a particular piece of multimedia content was viewed x times and selected y times by the audience for the campaign in which that piece of content was utilized) used for training the machine-learning model. In these embodiments, this past-performance data is randomly split into training sets, cross-validation sets, and test sets for assessing the effectiveness/accuracy of a given training run. In some embodiments, the model is re-trained at regular intervals as new data is accumulated/collected by the system or otherwise acquired. In these embodiments, “time-since campaign” may be a part of the training feature vector used to train the model, which results in training data from more recent campaigns having a higher influence on the model than training data from older campaigns.

Next, the system generates recommendations for the campaign. In certain embodiments, generating a recommendation comprises generating predicted performance metrics for each of a plurality of pieces of multimedia content to be broadcast by each of a plurality of platforms and/or individuals who broadcast streaming content. In certain embodiments, those performance metrics comprise performance metrics for a campaign to be broadcast by the platforms and/or individuals who broadcast streaming content. Those metrics may also comprise, in certain embodiments, at least one of a number of predicted selections of one or more pieces of multimedia content, a number of predicted visits to web pages linked to one or more pieces of multimedia content, a number of predicted views of one or more of the plurality of pieces of multimedia content, and a number of predicted times that one or more pieces of multimedia content was liked, linked, shared, or otherwise reacted to. In certain embodiments, the performance predictions 312 include raw performance metrics of a broadcaster or platform in a particular campaign, including but not limited to how many clicks a particular tracking link 214 received (automated tracking links 214 will be explained in more detail later), how many active viewers there were during the campaign, or how many social media engagements (FACEBOOK™ Likes, TWITTER™ Retweets) campaign-related social media posts received.

In certain embodiments, the output of this system also includes predictions of broadcaster performance based on the particular pieces of multimedia content instead of based on the overall campaign 314. In one embodiment, it could predict the number of clicks on a banner advertisement if the campaign were to include that piece of multimedia content. These predictions are calculated for all potential types of pieces of multimedia content in the system.

In certain embodiments, the predicted performance metrics comprise at least one of a reach score and an interactivity score for each of the at least one platforms and/or individuals who broadcast streaming content. Those values are now discussed in more detail.

In certain embodiments, the broadcaster performance predictions 312 include a normalized calculation of the broadcaster's reach (i.e. a score/value representing the size of the broadcaster's audience relative to other broadcasters in the system). This can be calculated as an average of normalized predicted audience values, so for a system with n social media and/or live streaming platforms, a broadcaster's audience of x on each platform, the reach score r for user j would be calculated as:

$${r}_{j} = \frac{{\sum }_{i}^{n} \frac{{x}_{i j}}{{x}_{i max}}}{n}$$

In certain embodiments, the reach score includes a weighting w for each platform based on entity preferences submitted during the initial campaign setup (e.g., if an entity really cares about reaching FACEBOOK™ audiences but not TWITTER™ audiences, they might specify a high w_{FACEBOOK™} but a low w_{TWITTER™}) For n social media and/or live streaming platforms, where w₀+w₁+ . . . +wₙ=1, reach r for user j would be calculated as:

$${r}_{j} = {\sum }_{i}^{n} \frac{{x}_{i j}}{{x}_{i max}} {w}_{i}$$

In certain embodiments, the broadcaster performance predictions 312 includes a score/value for the audience interactivity (i.e. an average of normalized interaction rates (e.g., click through rates on tracking links 214, which is a measure of the number of clicks over total views)). The interactivity v can be expressed for observed interactions o and total possible interactions t for n pieces of multimedia content (e.g., clickable banner, chatbot message) as:

$${v}_{j} = \frac{{\sum }_{i}^{n} \frac{\frac{{o}_{i j}}{{t}_{i j}}}{\frac{{o}_{i max}}{{t}_{i max}}}}{n}$$

In certain embodiments, receiving the recommendation of at least one piece of multimedia content comprises receiving scores/values relating to platforms and/or individuals who broadcast media content. In certain embodiments, the values are based on a weighted average of a subset of values generated by the machine-learning model. Those values may also be based on all of the values generated by the machine-learning model, or may be based on further calculations or analysis performed on the value generated by the machine-learning model. Weightings w are collected from the entity as a series of preferences (e.g., how important is total audience reach which would converted into wᵣ), where w₁+w₂+ . . . +wₙ=1.

As explained above, in certain embodiments, the values may comprise one or more of a broadcaster reach value and a broadcaster interactivity value. The principles explained above may also be used to incorporate other values as well; for example, a platform and/or individual affordability value. These values may be tied to the goals of the campaign. For example, if the campaign is a political campaign the values may comprise an estimate of the expected number of votes received, the number of voters whose minds may be changed, the number of unlikely voters inspired to vote, or any other value.

When an entity has initiated a new campaign, a broadcaster performance prediction 312 is generated for each pairing of new campaign C and broadcaster j, so that the predicted values for each pairing could be expressed as Cⱼ=(y₁ⱼ, y₂ⱼ, . . . , yₙⱼ). Each Cⱼ pairing is then fed into the ranking algorithm to determine the final broadcaster recommendation rankings 313.

Those platforms and/or individuals are ranked according to any relevant metric to produce recommendation rankings 313; for example, in certain embodiments, the scores/values are used to rank the platforms and/or individuals according to the goals of the entity. In certain embodiments, those rankings are sent back to the entity via the API 316. The rankings may also be sent back to the entity though any other means; for example, the entity may receive an email, text message, voice message, chat message, or any other communication that conveys the rankings and/or recommendations. The rankings may also alternatively or additionally be stored by the system. If stored, the rankings may be later accessed by the entity, or may later be used by the system to produce rankings and recommendations for other campaigns, or for additional analysis of the same campaign.

In some embodiments of the invention, the broadcaster recommendation rankings 313 are calculated as a subset of values from the broadcaster performance predictions 312, including but not limited to reach r and interactivity v. In certain embodiments, the broadcaster recommendation rankings are calculated using a value for affordability a, a normalized value for how expensive the broadcaster is (i.e. price per hour streamed, price per tweet, or any other pricing). In such embodiments, the ranking value b for broadcaster j for the new campaign C could be calculated as:

$${b}_{C j} = {\sum }_{i}^{n} {v}_{C j} {w}_{v} + {r}_{C j} {w}_{r} + {a}_{C j} {w}_{a} + … + {y}_{C j} {w}_{n}$$

These recommendations are then provided or stored, using any of the methods explained previously, as a list of broadcasters numbered 1 to m, where m is the total number of broadcasters in the system. The ranking of 1 is assigned to the broadcaster with the highest ranking score b, and the ranking of m is assigned to the broadcaster with the lowest b. This information is sent to the portal along with any relevant information about the broadcaster. In the embodiment where the broadcaster, platform, or campaign involves games, the information may include what game the broadcaster streams most, various social media stats, costs for working with the broadcaster, etc.

The same machine learning model that produced the broadcaster recommendations also returns suggested pieces of multimedia content. Predictions for the performance of pieces of multimedia content (the predicted performance of piece of multimedia content a for broadcaster j in campaign C 314), are used to calculate multimedia content type rankings 315 using a weighting nearly identical to those used to generate the broadcaster rankings 313. These rankings are also provided or stored, in any relevant method, as suggestions or rankings for which types of pieces of multimedia content are best to include in the campaign. In certain embodiments, the rankings also provide the scores/values relating to particular pieces of multimedia content.

Fourth, the campaign uses to recommendations to choose which broadcasters to work with. Using the generated rankings and other broadcaster information, the entity selects which broadcasters to partner with on the campaign.

In certain embodiments, the invention comprises a system for simulating an audience reaction to multimedia content. In certain embodiments, the invention comprises at least one server. In certain embodiments, the invention also comprises a first database containing information describing promotional campaigns comprised of a plurality of pieces of multimedia content. The information in the first database roughly corresponds to the first set of information described previously, and may be of the same breadth and detail.

In certain embodiments, the invention further comprises a second database containing information describing a plurality of platforms for broadcasting media content. The information stored in the second database roughly corresponds to the second set of information described previously, and may be of the same breadth and detail. In certain embodiments, the first and second databases are housed on a single server. The databases may also be housed on separate servers, or may be distributed across any number of servers.

In certain embodiments, the invention further comprises a machine-learning model. In certain embodiments, that model is trained to generate recommendations for one or more particular pieces of multimedia content to be broadcast by one or more particular platforms for broadcasting or individuals who broadcast multimedia content. In certain embodiments, the first and second databases each input information into the machine-learning model.

In certain embodiments, the machine-learning model is housed on a server configured for parallel processing. The model may also be housed on any other type of server, however, or may be distributed across a number of servers or computers.

In certain embodiments, the machine-learning model is a neural network. For example, the model may be a LSTM neural network or a deep convolutional neural network.

In certain embodiments, the invention further comprises an Internet portal site and API for entering information. In certain embodiments, that information is input to the first database. The Internet portal site may function in any suitable browser, and using any suitable operating system. In certain embodiments, the invention may further comprise an application residing on a mobile device; for example, an application on a handheld mobile device, a tablet device, or a piece of wearable technology.

In certain embodiments, the invention may further comprise one or more social media APIs, demographic data services, and chat applications for inputting information into the second database. The second database may also receive information from any other source.

The above data examples are not limiting. The system may use any, some, or all of the examples listed, and may use other data as well. The type of data used can also depend on any number of factors, from the availability of the data to the specific requests of the entity seeking analysis. Thus, the system may use any single type of data, or any combination of data in performing the analysis.

The campaign creation process could be housed in a single server, as pictured in 301, or as multiple servers. For example, the machine learning model could be stored in a separate server with hardware specifically chosen for the massively parallel processing necessary for big data computing tasks. The web portal 317 and the API 316 follow standard practices for building web applications. The source data for the broadcaster and multimedia content recommendation system are primarily housed in two databases: the broadcaster database 305 and the campaign database 306. These databases 305 and 306 may reside in the same database software on the same server or can be housed on entirely different machines.

Once the entity has selected the platforms and/or individuals and the pieces of multimedia content, the campaign moves from the creation stage to the execution stage. The execution system will be described through reference to FIG. 2. In these embodiments of the invention, pieces of multimedia content in the form of media, images, text, or any other form are distributed to any number of content creators or platforms across multiple channels. A campaign may be a blank slate; each piece of multimedia content may be uploaded or created through a form by a user to exist within the campaign. The pieces of multimedia content themselves may be static or dynamic, and may conditionally present themselves on a content creator's dashboard and livestream based on broadcast viewer activity or campaign specific actions such as giveaways or item purchases.

In certain embodiments, once the campaign is created it can be divided into Management 206 and Distribution 208. As part of the execution system, in some embodiments Distribution 208 occurs by propagating the selected pieces of multimedia content to all selected content creators inside of a specific campaign through the use of a Broadcaster Dashboard Module 209. In an exemplary embodiment, campaign preparation, execution, and evaluation is done through the Campaign Management Module 207; this includes general Management 206.

In the embodiments including Campaign Management Module 207, each system user is given a unique campaign management dashboard for which each associated campaign piece of multimedia content section is displayed. Users may create, edit, and delete each piece of multimedia content from this module. In certain embodiments, the user may create and upload a JPEG image as a static banner graphic, enter a desired target URL, and name the piece of multimedia content. In other embodiments, the user may create and upload any other form of audio, video, or text file. In certain embodiments, the user may create such pieces of multimedia content from the dashboard of Campaign Management Module 207.

In another exemplary embodiment, the system can import the pieces of multimedia content that are a part of the campaign from another location, either automatically or manually. For example, an entity could enter the web address of its website, and the system could retrieve all of the images found on the website. The entity could then select any or all of the imported images for use. In other embodiments, the system could import any other form of media, or any combination of media types, from the website or any other location. This automatic compilation of pieces of multimedia content reduces the user's need to upload or create the pieces of multimedia content themselves. In other embodiments, the system provides the ability for the user to create new pieces of multimedia content from the system dashboard.

Each content creator is given a unique Broadcaster Dashboard Module 209 for which each associated piece of multimedia content relating to the campaign is displayed. In a non-limiting example, pieces of multimedia content displayed range from static graphics, dynamic graphics, webpage captures, movies, animations, audiovisual streams, audio files, weblinks, coupons, games, virtual reality environments, augmented reality environments, mixed reality environments, URLs, text messages, and video to informational content. From this dashboard, content creators may be required to download pieces of multimedia content associated with a campaign or copy any associated text. In certain embodiments, pieces of multimedia content are fetched and automatically updated from a common database. The Broadcaster Dashboard Module 209 contains Suggested Action Queue 212 and Dynamic Broadcast Graphic Layer 213. The broadcaster dashboard module 209 also displays a copy of the text messages fed to the Chat Channel Bots 210.

In certain embodiments, Chat Channel Bots 210 are used to publish campaign messages across various chat channels available at third party websites. In certain embodiments, an IRC protocol bridge is used to post messages to the content creator's TWITCH™ chat channel at a timed interval set within the system.

In certain embodiments, Campaign Management Module 207 allows users to create and edit real-time chat message collections set with command-based or timed characteristics. In certain embodiments, Campaign Management Module 207 uses platform-specific scripts to deliver messages to chat rooms on third-party applications such as, but not limited to, TWITCH™ and DISCORD™ chat channels. Those who view the channel may type campaign-specific commands in order to trigger the delivery of certain results or messages in the chat room. In certain embodiments, a channel viewer could post a command in a chat channel to retrieve a campaign daily commercial deal, or a deal related to a specific category such as a graphics card, keyboard, or mouse (e.g., !mouse will cause the system to display the current mouse on sale). If the campaign is a political campaign, the channel viewer could enter a command into the chat channel that allows for the viewer to make a donation to a certain campaign or political party.

In certain embodiments, Suggested Action Queue 212 is displayed on a broadcaster dashboard module to elicit campaign-related actions from content creators on third-party services. In certain embodiments, actions are audited within the broadcaster dashboard module to confirm the action. In one embodiment, a suggested action is the respective message and image for a Tweet to be sent out by the content creator on their respective TWITTER™ accounts. Once the action has been executed, the content creator is instructed to enter the created Tweet URL. The system then confirms the action if the Tweet sent matches the Tweet requested. This principle could also be applied to any other type of posting; for example, a post to another social media website.

In certain embodiments, Versioning and AB Testing 211 allows for versions of pieces of multimedia content. In those embodiments, all pieces of multimedia content within the system exist as singular versions of a piece of multimedia content instance belonging to a single campaign. Each version of the piece of multimedia content carries unique attributes and metric values. In certain embodiments, an instance of the piece of multimedia content will carry its name and type while the versions of that instance will carry the actual media file data, click count, and target link. In certain embodiments, versions of the pieces of multimedia content may be historically compared from Campaign Management Module 207, in terms of performance and reinstated as the singular active version for that instance of the piece of multimedia content. In other embodiments, versions may be compared in any other manner. For example, the different versions may be displayed in a mobile application or the entity may receive a report regarding the different versions of the piece of multimedia content. Again, these examples are not limiting; any form or method of version comparison may be used.

In certain embodiments, a newer version of a static image may be compared against a previous version featuring a modified image. The user may compare the performance of the different versions and, if warranted, replace a newer version with a better performing version. For example, a current version of an advertisement may be replaced with a version that has performed better in the past, or may be replaced with a version that is projected to perform better than the current version.

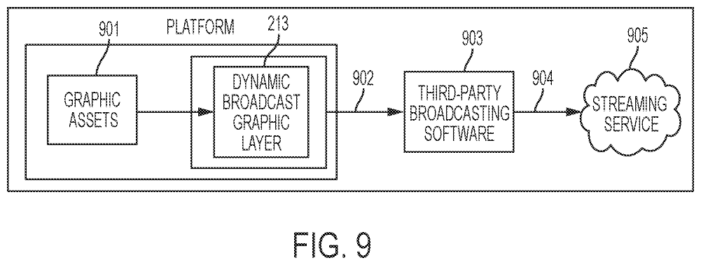

In certain embodiments, the execution system allows for pieces of multimedia content to be dynamically inserted into other media. This system is described in more detail through reference to FIG. 2 and FIG. 9. In certain embodiments, the entity uploads graphic assets 901 (e.g., pieces of multimedia content) or creates graphic assets 901 using the system. In certain embodiments, a Dynamic Broadcast Graphic Layer 213 is created for each broadcaster, that allows for the display of at least one piece of multimedia content. Dynamic Broadcast Graphic Layer 213 is then overlaid, via link 902, on the other content broadcast using Third-Party Broadcasting Software 903 to create an aggregated display of the streaming video feed and at least one piece of multimedia content. Third-Party Broadcasting Software 903 then broadcasts the aggregated display over link 904, which is then transmitted to the audience using Streaming Service 905.

In certain embodiments, Dynamic Broadcast Graphic Layer 213 is a web page generated by the system to dynamically display graphics on a broadcaster's stream. In one embodiment, the broadcaster captures the web page using Third-Party Broadcasting Software 903, such as Open Broadcaster Software, as a streaming scene. In those embodiments, the total aggregate of scenes such as camera feeds, game captures and graphic layers are then sent to Streaming Service 905, such as TWITCH™, to be broadcasted to their viewing audiences.

In certain embodiments, the Dynamic Broadcast Graphic Layer 213 is unique to each content creator account on the system. In those embodiments, content creators are expected to set up their Dynamic Broadcast Graphic Layer prior to streaming, but no further action is required for system to manage graphics on stream. Changes to Dynamic Broadcast Graphic Layer 213 may be, in those embodiments, automatically reflected on any streaming software capturing it. As such, the system is able to manage live outgoing stream graphics in real-time by adding, updating, or removing images, media or web content from the broadcaster's respective browser source. In certain embodiments, Dynamic Broadcast Graphic Layer 213 is automatically placed through a plugin from the broadcasting software. All web formats for images, videos and sounds from the live graphic layer are supported.

Certain embodiments employ a unified graphic system for a large number of broadcasters. In these embodiments, an entity may simultaneously manage live graphics in real-time. In certain embodiments, the dashboard may include live thumbnail previews of live streams. The entity can cause those streams to display a cohesive pattern of ads by triggering a graphic to be deployed simultaneously to each graphic layer appearing on each stream.

In the embodiments where Dynamic Broadcast Graphic Layer 213 is overlaid onto a video feed, it may be overlaid onto any type of video feed. Thus, the graphic layer may be overlaid onto prerecorded content (for example, a movie or episode of a television show), onto live broadcast content (for example, a political debate, a sporting event, or a user playing a game), or onto content that is procedurally generated as the audience is experiencing it.

In certain embodiments, the graphic layer may be overlaid on a video feed that is not actively receiving video data. For example, the graphic layer may be overlaid onto a video feed with only an active audio component, a video feed displaying a series of still images, or a video feed displaying a series of textual messages. In these embodiments, the graphic layer may similarly be overlaid onto a prerecorded, live broadcast, or procedurally generated feed.

The graphic layer may be overlaid onto a video feed in any manner. For example, the graphic layer may be overlaid as a border surrounding the perimeter of the feed or may be oriented along one or more sides of the feed. The graphic layer may also be overlaid in a semi-transparent manner, like a watermark. The graphic layer may be overlaid in the same position relative to the feed for the entirety of the feed, or may instead change places as the feed is being experienced by the audience. Thus, the graphic layer may be overlaid in any desired position or orientation.

In certain embodiments, the content of the graphic layer may be dynamic. For example, the graphic layer may begin with a particular piece of multimedia content overlaid on the feed, but may change to a different piece of multimedia content while the feed is ongoing. This change may occur at a predetermined time, at a random time, or in response to an event. Thus, these embodiments may further comprise at least one of adding at least one more piece of multimedia content displayed by the graphic layer, updating at least one piece of multimedia content displayed by the graphic layer, and replacing at least one piece of multimedia content displayed by the graphic layer with at least one different piece of multimedia content.

In certain embodiments of the present invention, the piece of multimedia content may be modified or updated in response to an event. For example, the piece of multimedia content may be changed in response to an audience reaction to the feed, an audience reaction to a current event, an audience reaction to the piece of multimedia content, or the occurrence of another event. For example, the piece of multimedia content may be changed in response to a current event, like the results of an election or the results of a sporting event. In certain embodiments, the event is based on third-party data provided by a public or private API call. In certain other embodiments, the event is based on performance data associated with the broadcast of the aggregated display.

In certain embodiments, a special piece of multimedia content may be displayed the moment a certain trigger is reached. In certain embodiments, that trigger may be any kind of counting or data tabulation. For example, a special graphic may displayed once a certain number of members of the audience participate in a campaign's call-to-action. For example, if the campaign's goal is to reach a certain dollar amount in donations, the graphic can be updated once that donation amount is reached. In other embodiments, the graphic may be updated in response to voting performed by the audience. The web format of the graphic allows the system to integrate socket or webhook technology to create graphic events based on triggers from third-party data. In certain embodiments, this data is fetched using public or private API calls, or available from proprietary metrics. For example, the data could be updated using TWITCH™ extensions, or any relevant extension; however, the input could also be received from any source. These dynamic graphics may also be related to other participating content creator's campaigns (e.g., a leaderboard; 1st place graphic for the leading participating content creator).

Thus, for example, a broadcaster's audience could vote for the piece of multimedia content that they wish to experience, and the graphic layer may be updated based on the results of the voting. In other embodiments, data tabulation relating to one broadcaster's channel may be compared to tabulation from another broadcaster's channel. In one non-limiting example, consider a trivia game played across a number of channels, with each broadcaster's audience considered as a separate team. The system may distribute a trivia question to each participating channel, and award points to the channel with the quickest submission of the correct answer. As each channel accumulates points, the graphic layer in each channel is updated to reflect the current score of each channel. This example is provided only to illustrate the point; the system can bridge input from any source into a dynamically generated graphic that is affected or altered based on that input in real-time.

In certain embodiments, changing, updating, or replacing the piece of multimedia content may be triggered by sentiment information from an audience of the broadcast of the aggregated display. For example, if it seems that the audience does not like a particular piece of multimedia content, the system may detect that the audience is having a negative response to the content and replace the content. In certain embodiments, the replacement piece of multimedia content is also selected based on audience sentiment data. Use of audience sentiment data is an area where, in certain embodiments, there is significant feedback/feed forward between the execution and evaluations systems. Thus, although the sentiment analysis is described in more detail in the discussion of the evaluation system and so occurs later within the present document, that evaluation and sentiment analysis may, in some embodiments, occur at the same time as execution of the campaign.

The embodiments where evaluation and execution are performed approximately concurrently allow the system to rapidly respond to audience sentiment regarding a particular piece of multimedia content. For example, the execution may cause a particular piece of multimedia content to be experienced by an audience. In these embodiments, the evaluation system then monitors the audience response to the piece of multimedia content. If the evaluation system determines that the audience is having a negative response to the piece of multimedia content, then in some embodiments the execution system may automatically replace the piece of multimedia content with another piece of multimedia content that has received better audience sentiment in the past.

In certain embodiments, the sentiment information is gathered from machine-learning model analysis of textual data generated by the audience, For example, in certain embodiments the feed may be accompanied by a chat window that the audience may enter textual data into. The system may evaluate the textual data entered by the audience to determine the audience's sentiment towards, for example, the piece of multimedia content, the broadcaster of the feed, an event, or any other source. In certain embodiments, this includes using machine-learning techniques to classify and/or store any meaning beyond the literal textual expressions of audience sentiment; for example, the system may classify and/or store the meaning of character strings, emotes, emojis, slang, or other such content relevant to or developed by that particular audience.

In certain embodiments, the action taken regarding the piece of multimedia content is triggered by the audience who is experiencing that piece of multimedia content. In other embodiments, however, replacing the at least one piece of multimedia content with at least one different piece of multimedia content is triggered by sentiment information from an audience of a broadcast of a different aggregated display. For example, the piece of multimedia content may be a scoreboard that is kept updated based on audience sentiment information aggregated across a number of different feeds. In other embodiments, the system may detect that a particular piece of multimedia content is receiving a negative reaction on a feed, and may replace that piece of multimedia content displayed on a second feed before the audience experiences a negative reaction to that piece of multimedia content.

In certain embodiments, separate versions of the same instance of a piece of multimedia content are shown simultaneously on multiple content creator livestreams. The system may then track the performance of the two versions of multimedia content to determine which version performs better. In certain embodiments, the system may then automatically assign the higher-performing version of the piece of multimedia content as the dominant and single active version.

In certain embodiments, the feed is a game that a particular user or audience is playing or experiencing in real time. For example, the feed could be an online multiplayer game, an online single player game, or an offline game. In certain embodiments, the game is a traditional game displayed on a display device. In other embodiments, the game is a virtual reality, augmented reality, or mixed reality game. In certain embodiments, the graphic layer is overlaid on the game screen; for example, around the perimeter of the game screen, or on one or more sides of the game screen. In other embodiments, the graphic layer is experienced by the player or audience as the game progresses. For example, if the game takes place in a town or city, the graphic layer could overlay a piece of multimedia content onto a billboard within the city. That piece of multimedia content could also change as the game progresses, either at a predetermined time, randomly, or in response to an event. For example, the at least one piece of multimedia content depicted on the billboard in the game could be a scoreboard, and that scoreboard could be updated based on user action, an outside event, audience sentiment, audience action, or the sentiment or action of an audience of another feed. Again, these examples are not limiting. In other embodiments, instance data of a particular streamer may be sent to the developer of the game, publisher of the game, or another relevant party, so that the developer or other party may place assets in or otherwise alter the game state directly in the instance of the game itself. For example, in these embodiments the developer may modify the experience of the person playing or otherwise experiencing the game as that person is playing or experiencing it. The present invention may use any method to overlay or incorporate the graphic layer into a feed. Thus, in certain embodiments overlaying the graphic layer on a streaming video feed comprises inserting the at least one piece of multimedia content within a virtual environment being displayed within the streaming video feed.

The piece of multimedia content may be of any form. In certain embodiments, the at least one piece of multimedia content comprises at least one of a static graphic, a dynamic graphic, a webpage capture, a movie, an animation, an audiovisual stream, an audio file, a weblink, a coupon, a cartoon, a game, a virtual reality environment, an augmented reality environment, and textual content. These are only examples; the piece of multimedia content may take any form including, as explained earlier, a combination of pieces of multimedia content.

In certain embodiments, the at least one piece of multimedia content is associated with a link to an Internet resource; for example, Auto-Generated Tracking Links 214. In certain embodiments, the link to an Internet resource is uniquely associated with at least one of the broadcaster of the aggregated display, the at least one piece of multimedia content, and the creator and/or entity associated with the at least one piece of multimedia content. In certain embodiments, the system may record audience member selection of the link to the Internet resource.

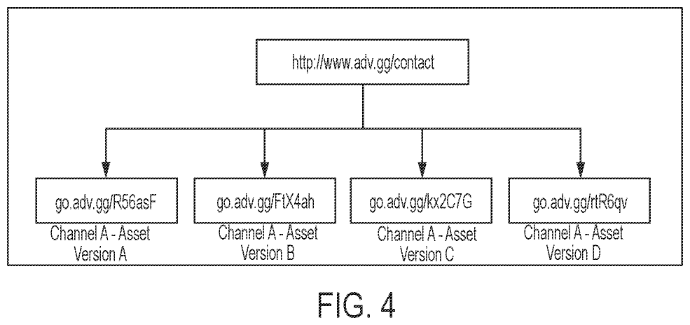

FIG. 4 depicts examples of Auto-Generated Tracking Links 214. In certain embodiments, all pieces of multimedia content within the system carry a unique, shortened, auto-generated URL. Each link is associated to a specific combination of a campaign channel and campaign version of the piece of multimedia content. In a non-limiting example, a user will set a series of conventional target URLs meant as target destinations for content creators to direct their viewers towards. When a piece of multimedia content is created or uploaded to the system, the user is prompted to select from this list of existing target links. The target links are then used to generate a series of shortened links of the form GO.AVD.GG/XXXXXX where X is a conventional base64 encoded character. In its entirety, the use of unique links allows the system to determine exact attribution for a campaign's pieces of multimedia content to be used for performance-based metrics in the evaluation phase of the platform.

In one embodiment, a TWITCH™ viewer clicks on the static advertisement which links to a designated web page on the user's target website. The click is recorded based on date-time, channel, and the version of the piece of multimedia content on the system databases to be later aggregated into metric values for total clicks across parameters such as single channels, or single versions of the piece of multimedia content. In certain embodiments, the graphic layer is overlaid onto the feed using a plugin from software used for broadcasting the aggregate display.

In certain embodiments, a general aim of Execution stage 102 is to automate, as much as possible, the distribution of pieces of multimedia content related to the campaign for the broadcasters. In certain embodiments, however, it can be difficult for the system to gain access to certain processes, such as configuring the broadcasters' streaming software to display the Dynamic Broadcast Graphic Layer 213. In embodiments where those processes cannot be accessed, implementing those features requires manual intervention on the part of the broadcaster. The Compliance system, a subset of Execution stage 102, details the invention's processes for programmatically confirming that the broadcaster has taken the appropriate manual steps and remains in compliance with the terms of the campaign.

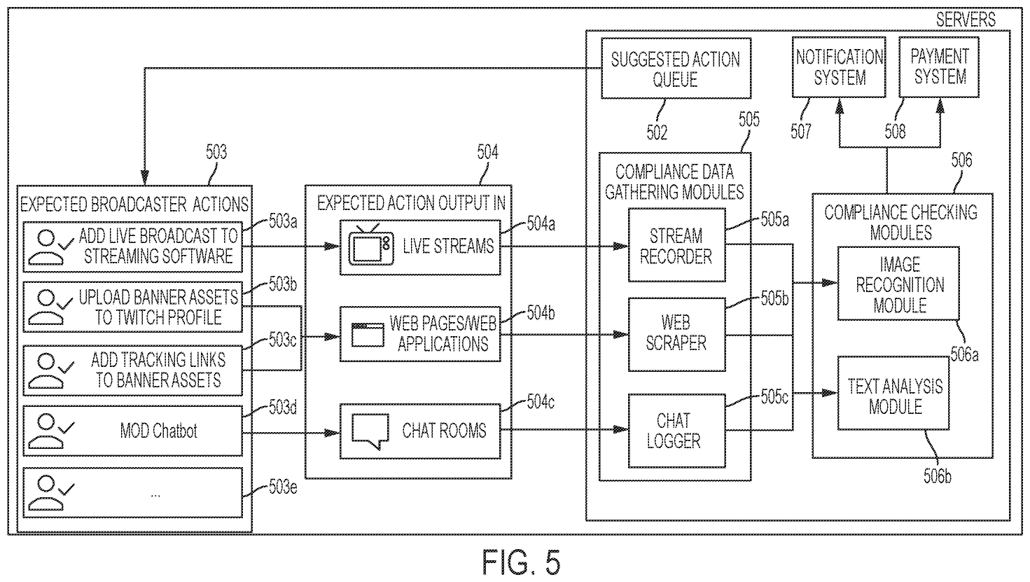

FIG. 5 is a diagram depicting an exemplary Compliance system. In certain embodiments, the compliance cycle begins with the Broadcaster receiving an action or set of actions in Suggested Action Queue 502 (which is the same as Suggested Action Queue 305 described above). In these embodiments, Suggested Action Queue 502 is a list of concrete actions 503 that the broadcaster must execute in order to fulfill their responsibilities during the campaign. Those actions may be, in certain embodiments, displayed in web portal 317 for the broadcaster.

In certain embodiments, each of these actions will have an expected observable output 504, which the system can monitor to ensure the appropriate action has been taken. For example, if the required action is Add Dynamic Live Broadcast Graphic Layer to streaming software 503a, the expected observable output would be that the Dynamic Broadcast Graphic Layer 213 should be visible in the broadcaster's live streams 504a. If the dynamic graphic layer is not visible, then the broadcaster is not in compliance.

Thus, in certain embodiments at least one broadcast by the selected one or more individuals or platforms for broadcasting is monitored to determine compliance with the campaign. Monitoring generally entails ensuring that the selected individual or platform is taking the actions that they are required to take by the campaign. In certain embodiments, monitoring comprises one or more of recording a video of a broadcast, recording screenshots of a broadcast video, downloading code from a web page, downloading one or more embedded media files from a webpage, recording a text stream, recording an audio stream, and recording a video stream. In certain embodiments, monitoring further comprises analyzing the monitored broadcast to determine whether the at least one piece of multimedia content has been broadcast by the selected one or more of the plurality of individuals/platforms. Compliance with the campaign, for example by broadcasting the at least one piece of multimedia content, may be determined, in certain embodiments, by performing one or more of image recognition on one or more recorded images or videos, audio recognition on one or more recorded streams with audio content, and textual recognition on streams with textual content.

In certain embodiments, each expected output may require its own data gathering module 505 for collecting the requisite data for determining whether the broadcaster is in compliance. In other embodiments, the same module collects the requisite data for all expected output. In certain embodiments, expected action output is observable in the broadcaster's live streams 504a. In certain embodiments, data from live streams is collected using the stream recorder 505a.

In certain embodiments, the stream recorder 505a loads a user's stream in a webpage (such as the user's TWITCH™ page) in a headless browser (such as headless chrome or phantomjs) and takes a “screenshot” of the TWITCH™ stream at regular intervals (e.g., every 5 minutes). In such embodiments, the output of the stream recorder is a series of still images of the live stream, saved at regular intervals. In certain embodiments, the stream recorder 505a opens a connection to the live stream directly and writes a short video clip of the stream. This video clip can then also be deconstructed into individual frames for analysis.

In certain embodiments, expected action output is observable in various web pages or web applications 504b, such as the broadcaster's TWITCH™ Profile page. Data may be collected from web pages/web applications using a web scraper 505b. A “web scraper” is a type of application that is used to fetch web data as code. In certain embodiments, the embedded web scraper will download both the source code of the web page (its current HTML and javascript) for later parsing, and any embedded media files (e.g., images and videos).

In certain embodiments, expected actions are observable in chat programs/chat rooms, such as the IRC-based chat in TWITCH™. In such cases, a chat recorder 505c is used to record the textual content of the chat for later use and analysis. Once the observable output has been collected, the relevant data is passed to Compliance Checking Module 506. Compliance Checking Module 506 may include a single module, or in certain environments it may include more than one module. The received data is compared to the expected output. If the output differs from the expect output, the broadcaster may be flagged as noncompliant.

In certain embodiments, compliance checking modules include an Image Recognition Module 506a, which determined whether one image is the same as or contains a target image. For example, if the Dynamic Live Broadcast Graphic Layer is meant to display an image (e.g., an advertisement for a given product or campaign) as part of the viewer's stream, the advertisement image would be passed into the image recognition module as the target image, and then compared to images captured in the stream recorder. If the advertisement image is not found inside the captured stream images, the broadcaster may be flagged as noncompliant.

In certain embodiments, image recognition is performed using a variant of Template Matching, which involves sliding the target image over the source image at various scales and calculating the average pixel difference. If the average difference at a certain location/scale combination is below a certain threshold, the template (i.e. the expected image) is present and the broadcaster is compliant.

In certain embodiments, if the source image I has dimensions W×H and template T has dimensions w×h, then a comparison matrix R of dimensions (W−w+1)×(H−h+1) can be calculated as:

$${R}_{( x , y )} = {\sum }_{{x}^{′} = 0 , {y}^{′} = 0}^{w , h} {( T ( {x}^{′} , {y}^{′} ) - I ( x + {x}^{′} , y + {y}^{′} ) )}^{2}$$

If any point in the result matrix R is determined to be below a certain threshold, the image is considered a match, and the broadcaster is likely in compliance.

In certain embodiments, image recognition is done using a variant of Feature Detection, such as SIFT (Scale-Invariant Feature Transform) or FLANN (Fast Library for Approximate Nearest Neighbors).

In certain embodiments, image recognition is done using a variant of R-CNN (Region-based Convolutional Neural Networks). In this embodiment, a large training set of source images taken from broadcaster's live streams and scraped pages may be tagged according to whether they contain one of a set of target images. In certain embodiments, the training data is further expanded by manually compositing the target images in duplicates of the source images, at different scales, to create a larger number of positive responses than could be created merely through manual image scraping/collecting. This CNN is streamlined—rather than requiring the Neural Network to extrapolate generalizable features, it only needs to identify whether a particular image may exist in the source image (in other words, rather than having to ask “does this image contain a cat,” the CNN is optimized for the narrower question of “does this image contain this image of a cat”).

In certain embodiments, compliance checking modules include Text Analysis Module 506b. In those embodiments, this module checks text streams and scraped data to ensure the expected text is present. For example, a channel chatbot 210 may be set up to post a given message at regular intervals, and the broadcaster may be required to give the chatbot moderator permissions (which give the chatbot elevated privileges). If the chatbot has been set up but the expected message is not detected, the broadcaster may be flagged as noncompliant.

In certain embodiments, the system may take at least one of a number of actions against a broadcaster or platform that is determined to be noncompliant. In certain embodiments, the noncompliance information (for example, the name of the broadcaster, the expected output, and the observed output, as well as any other relevant data) will be sent to a notification system. This system may send an alert to the entity running the campaign regarding noncompliance. This alert may be sent by, for example, email, text message, other message, phone call, or any other means of communication. Once notified, the entity may take any responsive action; for example, contacting the broadcaster or platform or manually verifying noncompliance. In certain embodiments, broadcasters will be notified of their noncompliance and allowed to remedy the noncompliance.

In certain embodiments, the noncompliance will be sent to the payment system. In those embodiments, certain actions may be taken by the payment system in an attempt to encourage compliance. For example, payments may be held until the broadcaster resumes compliance. Once the broadcaster or platform is back in compliance, in certain embodiments payments would automatically resume. In other embodiments, payments would not resume without manual verification of compliance.

In certain embodiments, compliance is recorded as a binary; i.e., a broadcaster or platform is either compliant or noncompliant. In certain embodiments, compliance is recorded as a spectrum ranging from 100% compliant to 0% compliant, with the compliance score calculated as the percentage of expected actions taken. In that embodiment, actions taken against the broadcaster can scale with the level of non-compliance, with small infractions resulting in smaller penalties (for example, worse ad placement or slightly reduced payment), and more serious infractions resulting in larger penalties (for example, inability to join new campaigns or a complete payment stoppage).

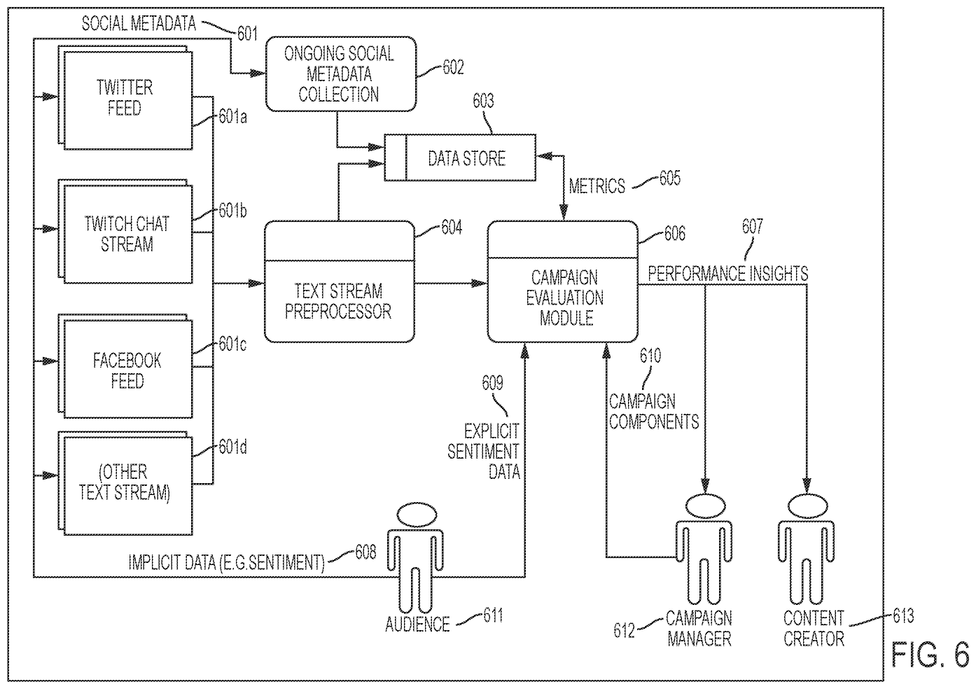

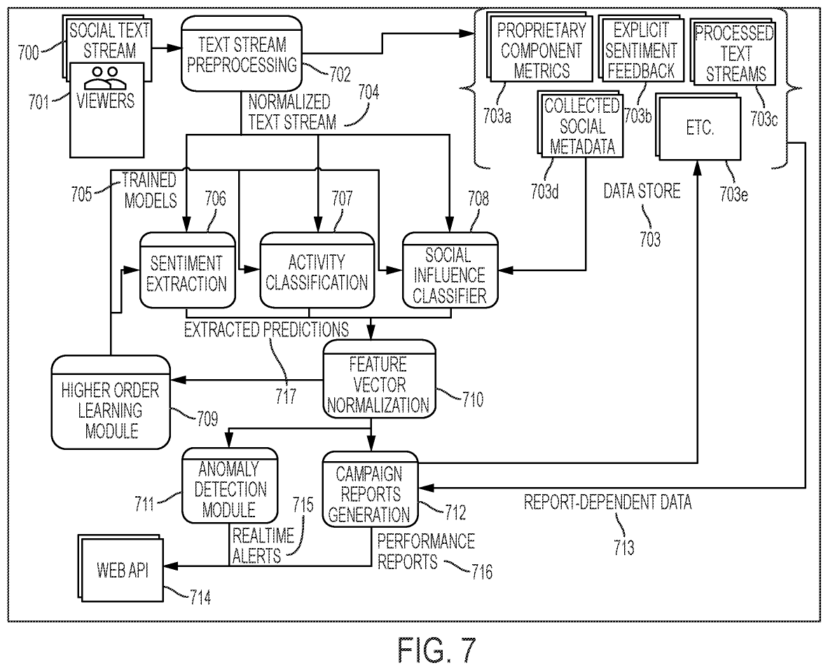

Evaluation stage 103 will now be described in more detail through reference to FIG. 2, FIG. 6, and FIG. 7. In certain embodiments, Evaluation stage 103 delivers campaign performance insight to users and broadcasters by extracting implicit data about the audience from external channels (for example, FACEBOOK™, TWITCH™ chat channels, and TWITTER™); and collecting data directly from the audience within the system in the form of click-through counts, explicit sentiment from embeddable on-stream widgets, etc.

FIG. 2 depicts the process at a high level. In certain embodiments, Evaluation Stage 103 relies on Proprietary Metrics 217, including data generated by Auto-Generated Tracking Links 214, as well as Third-Party Metrics 216, to generate Campaign Sentiment Metrics 215. The process for generating the proprietary metrics will be described in more detail later, but at a high level involves, in certain embodiments, analyzing the audience response to the campaign, content creator, media, or other factors to determine an audience reaction and/or sentiment. Third Party Metrics 216 could be any relevant metric from any third party. Once the metrics are compiled, they are analyzed to generate Campaign Sentiment Metrics 215. Campaign Sentiment Metrics 215, Third-Party Metrics 216, and Proprietary Metrics 217 are then fed into Machine Learning Model 218 to evaluate the campaign. The results of Machine Learning Model 218 can then be fed back to Creation stage 101 using link 105, and/or to Execution stage 102 using link 104.

In certain exemplary embodiments, the system includes machine-learning methods for analyzing and classifying textual messages. In those embodiments, the methods comprise preprocessing at least one text stream to extract structured text units, classifying the structured text units to predict one or more of a sentiment value, activity class, and social influence score for each of the structured text units, and outputting a vector comprising the extracted predictions. In certain embodiments, the text stream comprises a chat channel feed or a social media feed. In other embodiments, the text stream may be a transcription of speech from an audio or video stream (such as a livestream of a broadcaster, a pre-recorded video on demand, or recorded audio such as a podcast).

In certain embodiments, the text stream is preprocessed before classification. In certain embodiments, preprocessing comprises one or more of tokenization, n-gram generation, hashing, spellcheck, and stemming. However, preprocessing may also occur using other methods.

FIG. 6 depicts the overall process. In certain embodiments, evaluation is performed by analyzing the textual data produced by Audience 611. The textual data may be received, fetched, or input to the system from any source; for example, the source may be Twitter Feed 601a, Twitch Chat Stream 601b, Facebook Feed 601c, or any other Text Stream 601d. In certain embodiments, the system also collects Social Metadata 601 separately or from text streams 601a-601d, as part of Ongoing Social Metadata Collection 602. That ongoing social metadata collection is stored in Data Store 603, which may be a single data store, separate data stores, distributed data stores, or any other method of storing data.

In certain embodiments, the extracted textual data is sent to Text Stream Preprocessor 604 after being collected. Text Stream Preprocessor 604 preprocesses the text stream into a normalized form for later analysis. In certain embodiments, the preprocessed text is provided to Data Store 603. In other embodiments, as will be explained in more detail, the preprocessed text is analyzed for sentiment data to determine how Audience 611 has reacted to certain media. In certain embodiments, that analysis is performed in Campaign Evaluation Module 606.

Campaign Evaluation Module 606 takes Metrics 605 from Data Store 603, text data from Text Stream Preprocessor 604, Explicit Sentiment Data 609 from Audience 611, and any Campaign Components 610 provided by Campaign Manager 612 (campaign goals, target audience, or any other metrics provided by the manager), and uses that data to analyze the performance of a piece of multimedia content, campaign, or other factor or combination of factors. Upon analyzing that data, Campaign Evaluation Module 606 generates Performance Insights 607. Those insights may provide relevant data or conclusions regarding the campaign, a piece of multimedia content, or any other relevant metric.

In certain embodiments, Campaign Evaluation Module 606 provides Performance Insights 607 and provides them to both Campaign Manager 612 and Content Creator 613. In other embodiments, the compiled data may be provided to other interested parties as well, or to only a single party (for example, only to Campaign Manager 612).

In certain embodiments, Audience 611 generates both Explicit Sentiment Data 609 and Implicit Sentiment Data 608. In certain embodiments, Explicit Sentiment Data 609 is provided to Campaign Evaluation Module 606.

FIG. 7 depicts analysis of the textual data generated by the audience in more detail. The text stream preprocessing module 702 is a collection of syntactic and simple semantic operations including tokenization, n-gram generation, stemming, spellcheck, hashing, etc. For example, during tokenization, the textual messages from Social Text Stream 700 produced by Viewers 701 are segmented into linguistic units, such as individual words, phrases, sentences, and characters/punctuation. During stemming, words are reduced to their common base part by removing suffixes and other affixes. Spellcheck helps improve the input into the system by catching and correcting common errors.

Social Text Stream 700 may be received or fetched from any relevant text stream. It may be, for example, the chat window accompanying a media stream, a social media feed, a document, or any other textual sequence.

Preprocessing 702 produces Normalized Text Stream 704. Normalized Text Stream 704 processes the text stream into normalized, structured text units that can be used by the rest of the system. Following preprocessing, the structured text units, referred to as messages, can subsequently be processed in parallel by each classifier module (i.e., Sentiment Extraction 706, Activity Classification 707, Social Influence Classifier 708).

Data store 703 provides data that can be used by Social Influence Classifier 708. Data store 703 stores Proprietary Component Metrics 703a, Explicit Sentiment Feedback 703b, Processed Text Streams 703c, Collected Social Metadata 703d, and other data 703e, for determining the social influence or other relevant weight of the text extracted from the stream.

In certain embodiments, the structured text units are classified once they are extracted. In certain embodiments, classifying the structured text units is performed in parallel by a plurality of classifiers. Each classifier uses the most performant model, as provided by the Higher Order Learning Module 709, to predict the class that the message belongs to and adjust the overall predicted class for the channel-viewer pair. Thus, Higher Order Learning Module 709 provides Trained Models 705 for use by each classification module 706-708. For example, a new chat message enters the Sentiment Extraction Module 706. The Classifier produces a float value in the range 0.0 to 1.0 where 0.0 is entirely negative sentiment valence for the message, and 1.0 indicates a completely positive sentiment. In one embodiment, this value is then multiplied by the net vector product of the social graph of the channel to adjust the running average weighted value of sentiment for a given channel. A similar calculation can be performed using the message author's social graph. The classifiers are Deep Convolutional Neural Networks. The training takes place separately from the classification, allowing more efficient utilization of computational resources. Training itself takes place in Higher Order Learning Module 709.

The same message, entering, for example, the Activity Classification Module 707, would use its current model to predict additional classes to which the message belongs. In certain embodiments, in addition to being positive or negative, the message could be classified as, for example, Engaged, Toxic, Informative, Relevant, or any other relevant classification. For example, a message that conveys positive sentiment about a piece of multimedia content, but does so using vulgar language or derogatory language about other content, could be classified as both “Toxic” and “positive.” As another example, a message that expresses a negative opinion about a particular piece of multimedia content using vulgar language but also attempts to explain the reasons behind that negative opinion could be classified as “negative,” “Toxic,” and “Informative.” The particular classes may be specified by entity managers or by the system itself in the default case. These predictions are used to generate higher-level, ongoing evaluations of the channels and broadcasters themselves, which enables recommendations, filtering, etc.

In certain embodiments, the messages may also be weighted based on the source of the message; that is, a social influence score may be calculated based at least in part on the social influence of a broadcaster associated with at least one text stream. The Collected Social Metadata 703d allows the system to calculate a socially-weighted score for each Message and for each Broadcaster, whereby a broadcaster or social influencer with a larger and/or more engaged audience will have a higher score for the weighted class tag than an influencer with a smaller or less engaged audience. The social influence I of a given Message, m∈M, e.g., a Tweet, is calculated via recursive algorithm I(m) where R(m) is the set of responses to m, i.e. retweets, @messages following mᵢ but prior to mᵢ+1, etc. If E(m) represents the count of likes or other explicit engagement metrics, and D(m) represents the Distribution of Message m, i.e. the number of followers, then we have

$$I ( m ) = {\sum }_{{m}_{j} ∈ R ( m )} \frac{I ( {m}_{j} ) E ( {m}_{i} )}{D ( {m}_{i} )}$$

These predictions are consumed by a range of downstream modules. The Feature Vector Normalization Module 710 is simply concerned with providing uniform feature vectors (i.e. predictions) to the subsequent consumers; thus, it normalizes Extracted Predictions 717. Especially in the case of the Higher Order Learning Module 709, it is valuable to be able to combine the predictions into uniform inputs to subsequent learning modules.

In certain embodiments, a report on the text stream from the vector comprising the extracted predictions is generated. Campaign Report Generation Module 712 takes as input these normalized prediction vectors, as well as explicitly tracked data 713 from Data Store 703, and as output creates reports 716 on campaign and broadcaster performance, presenting visualizations and data tables that can be customized to the desires of individual entity managers and broadcasters. Report 716 may be in any form; for example, email, chat message, text message, or any other means. In certain embodiments, the report may be provided to Web API 714.

In certain embodiments, the system may also analyze a real-time stream of extracted prediction vectors to generate an anomaly score; thus, the system may detect anomalies in audience sentiment. In certain embodiments, Anomaly Detection Module 711 also consumes the normalized prediction vectors. Using Recurrent Neural Networks, a Hierarchical Temporal Memory/Cortical Learning Algorithm, or a hybrid approach combining the related techniques, Anomaly Detection Module 711 takes as input a real-time stream of prediction vectors, and produces as output a real-time varying anomaly score in the range 0.0 to 1.0 where 0.0 is perfectly expected, and 1.0 is perfectly anomalous. By performing this calculation on the output of the upstream predictions, Anomaly Detection Module 711 can detect, in a non-limiting example, changes in sentiment in a chat stream.

For example, consider an audience of a particular broadcaster or platform that is generally Positive and Engaged. If, after a new piece of multimedia content is deployed, the Anomaly Detection Module detects that the audience has become Negative and Toxic, that may be cause for consideration whether the new piece of multimedia content is causing this particular reaction. The Anomaly Detection Module can detect this change in attitude, and thus enable the entity to intervene and deploy a new piece of multimedia content before too much ill will has accrued.

Moreover, in certain embodiments, if a particular streamer is suddenly getting an anomalously negative reaction, the entity manager may shift funds away from that streamer before a public backlash can associate the entity with the controversial streamer. Conversely, Anomaly Detection Module 711 allows entity managers to receive real-time opportunity alerts if, for example, a particular channel is gaining followers at an unusually rapid rate, has a positive upswing in sentiment, etc. In certain embodiments, real-time alerts may be generated if the anomaly score is greater than a threshold value.

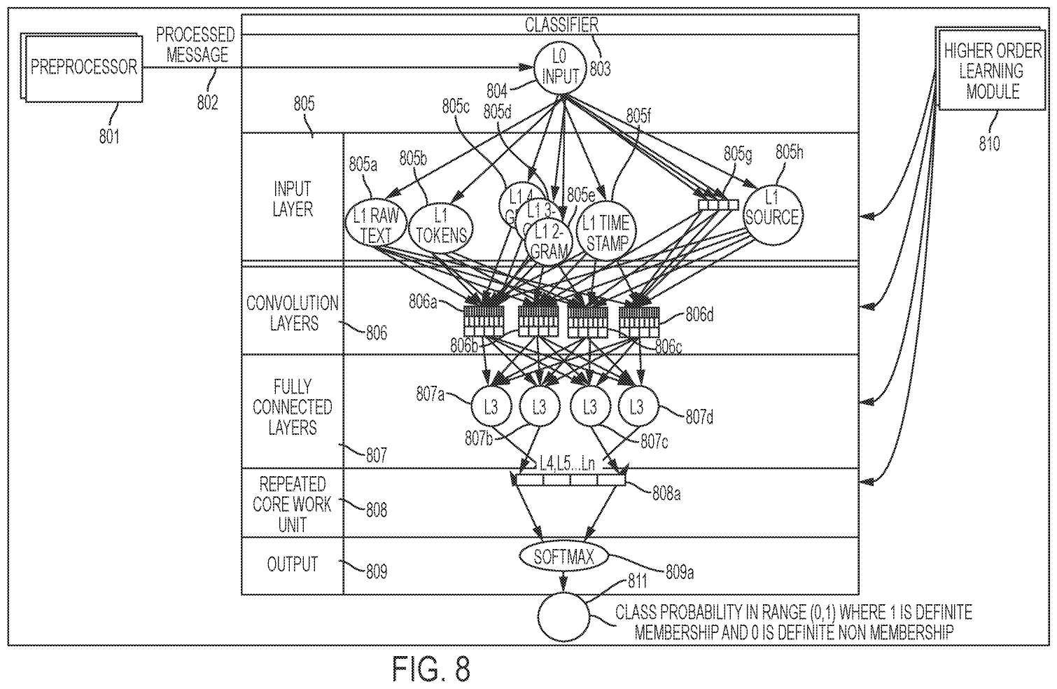

FIG. 8 depicts an exemplary neural network that is used in certain embodiments of the invention. While the artificial neural network architecture depicted in the exemplary embodiment of FIG. 8 is a deep convolutional neural network, those of skill in the art would recognize that other artificial neural network architectures could be utilized in the systems and to perform the functionality described herein—for example, a recurrent neural network. The system could be implemented using any artificial neural network, or could instead be implemented using a hybrid artificial neural network architecture.

As previously explained, in this embodiment, text is preprocessed at Preprocessor 801 to produce Processed Message 802. Preprocessing the text stream ensures that the text is in a format that can be used by the neural network. In some embodiments, Processed Message 802 comprises the raw test of the message itself and an associated feature vector obtained from the preprocessing of the text stream. In these embodiments, the feature vector may comprise a number of features based on, for example, the tokens in the preprocessed text stream; the n-grams in the preprocessed text; a time and/or date associated with the preprocessed text stream; the source (i.e. an author of the text, or a forum in which the text appeared, such as a chat channel or chat room); or other such indicia or characteristics of the preprocessed text stream.

After preprocessing, in certain embodiments Processed Message 802 is then input to one or more classifiers (for example, classifiers 706-708 shown in FIG. 7). Classifier 803 in FIG. 8 is, in certain embodiments, such a classifier. In certain embodiments, Processed Message 802 is received as L0 (i.e., 0th level) input 804. This is the first stage of classification using the exemplary neural network depicted in FIG. 8.

In certain embodiments, Processed Message 802 is fed into Input Layer 805 after being received at L0 Input 804. In Input Layer 805, Processed Message 802 is broken into its constituent parts and data 805a-805h, such as (for example) the individual features contained within a feature vector associated with Processed Message 802.

In certain embodiments, the data 805a-805h from Input Layer 805 are then fed into one or more Convolutional Layers 806. In some such embodiments, data 805a-805h from Input Layer 805 is input into the one or more Convolutional Layers 806 in the form of one or more matrices, in which each matrix may represent, for example, a sentence, a document, or a text stream, and each row of the matrix may represent a token, a word or a character.

In these embodiments, each Convolutional Layer 806 may contain one or more learnable filters. The height of the filters may vary (e.g., 2 matrix cells, 3 matrix cells, 4 matrix cells), and the width of each filter may be equal to the width of the matrix. Each of the filters can perform convolution on the matrix, which can be used to generate one or more feature maps. In some embodiments, the Convolutional Layer 806 may use zero-padding to perform wide convolution. In other embodiments, Convolutional Layer 806 may perform narrow convolution without zero-padding. In embodiments with a plurality of Convolutional Layers 806, the output feature maps of subsequent Convolutional Layers 806 may represent progressively more complex/higher-level features.

In some embodiments, each of the one or more Convolutional Layers 806 may comprise a pooling layer that follows each Convolutional Layer 806. In these embodiments, the pooling layer subsamples the one or more feature maps output by a Convolutional Layer 806. In some embodiments, the pooling layer outputs a fixed size output matrix from each of the one or more feature maps output by the Convolutional Layer 806. In some embodiments, a pooling layer may perform average pooling, or variants thereof. In other embodiments, a pooling layer may perform max pooling, or variants thereof.

In certain embodiments, the output of the one or more Convolutional Layers 806 (and, in some embodiments, the one or more associated pooling layer(s)) is then input into one or more Fully Connected Layers 807. In the one or more Fully Connected Layers 807, each neuron in a Fully Connected Layer 807 is connected to all activations in the preceding layer. In these embodiments, the one or more Fully Connected Layers 807 perform the relatively higher-level reasoning in the neural network, and output a vector 808a representing the probabilities that the processed message belongs to the one or more different classes that the Classifier 803 is capable of predicting.

In certain embodiments, the output vector 808a of Fully Connected Layers 807 may then be output into Repeated Core Work Unit 808. In some embodiments, the resulting output vector 808a may be fed into a softmax function (or normalized exponential function) 809a which outputs a class probability 811 for the Processed Message 802.

In these embodiments, the output of Classifier 803 (in some embodiments, the output of the softmax function 809a) is a probabilistic distribution representing whether Processed Message 802 belongs in that the one or more particular classes that the Classifier 803 is capable of predicting. For example, the neural network could output a probability that Processed Message 802 is a “positive” message. In certain embodiments, the probability is expressed as a float value in the range from 0.0 to 1.0, where 0.0 signifies definite non-membership (in the previous example, a definite conclusion that Processed Message 802 is not positive), and 1.0 signifies definite membership (in the previous example, a definite conclusion that Processed Message 802 is positive).

In certain embodiments, at each layer one or more Higher Order Learning Modules 810 adjusts and tests variations in the model architecture. In these embodiments, training takes place in the Higher Order Learning Modules 810, separately from the classification performed by Classifier 803, which allows for more efficient utilization of computational resources.

The examples described above and depicted in FIGS. 1-9 are only illustrative, and it will be readily seen by one of ordinary skill in the art that the present invention fulfills all of the objectives set forth above. After reading the foregoing specification, one of ordinary skill will be able to effect various changes, substitutions of equivalents, and various other embodiments of the invention as broadly discussed therein.

1. A machine-learning based method for simulating the performance of multimedia content, comprising:
receiving a first set of information describing desired performance parameters for at least one piece of multimedia content;
receiving a second set of information describing characteristics of at least one platform for broadcasting multimedia content;
inputting the first set of information and the second set of information into a machine learning model;
simulating, in the machine learning model, the performance of the at least one piece of multimedia content when broadcast by the at least one platform for broadcasting multimedia content;
generating, in the machine learning model, a recommendation of the at least one piece of multimedia content to broadcast on the at least one platform for broadcasting multimedia content; and
receiving, from the machine learning model, the recommendation of the at least one piece of multimedia content to broadcast on the at least one platform for broadcasting multimedia content.

2. The machine-learning based method of claim 1, wherein the at least one piece of multimedia content comprises at least one of a static graphic, a dynamic graphic, a webpage capture, a movie, an animation, an audiovisual stream, an audio file, a weblink, a coupon, a game, a virtual reality environment, an augmented reality environment, a mixed reality environment, and textual content.

3. The machine-learning based method of claim 1, wherein the at least one piece of multimedia content comprises at least one promotional campaign comprised of a plurality of pieces of multimedia content.

4-8. (canceled)

9. The machine-learning based method of claim 3, wherein the first set of information comprises information about an entity sponsoring the at least one promotional campaign.

10. (canceled)

11. The machine-learning based method of claim 1, wherein the first set of information comprises performance data for a plurality of pieces of previously broadcast multimedia content.

12-26. (canceled)

27. The machine-learning based method of claim 1, further comprising the step of training the machine learning model by inputting performance data for a plurality of pieces of previously broadcast multimedia content and broadcaster data describing one or more platforms that previously broadcast the plurality of pieces of previously broadcast multimedia content prior to inputting the first set of information and the second set of information into the machine learning model.

28-29. (canceled)

30. The machine-learning based method of claim 1, further comprising the step of filtering the second set of information prior to inputting the first set of information and the second set of information into the machine learning model.

31. The machine-learning based method of claim 30, wherein filtering the second set of information comprises eliminating one or more individuals who broadcast streaming video content from a list of potential candidates for failing to pass through at least one filter.

32-33. (canceled)

34. The machine-learning based method of claim 1, wherein the step of generating a recommendation of at least one piece of multimedia content to broadcast on at least one platform for broadcasting multimedia content comprises generating predicted performance metrics for each of a plurality of pieces of multimedia content to be broadcast by each of a plurality of individuals who broadcast streaming video content.

35. The machine-learning based method of claim 34, wherein the predicted performance metrics comprise performance metrics for a promotional campaign to be broadcast by each of the plurality of individuals who broadcast streaming video content.

36-37. (canceled)

38. The machine-learning based method of claim 1, wherein receiving the recommendation of at least one piece of multimedia content to broadcast on at least one platform for broadcasting multimedia content comprises receiving values relating to a plurality of individuals who broadcast media content.

39-40. (canceled)

41. The machine-learning based method of claim 38, further comprising selecting one or more of the plurality of individuals who broadcast media content to broadcast at least one piece of multimedia content.

42-45. (canceled)

46. The machine-learning based method of claim 1, wherein receiving the recommendation of at least one piece of multimedia content to broadcast on at least one platform for broadcasting multimedia content comprises receiving scores of a plurality of pieces of multimedia content to be broadcast.

47. (canceled)

48. A machine-learning system for simulating audience reaction to multimedia content, comprising:
at least one server;
a first database containing information describing a plurality of pieces of multimedia content;
a second database containing information describing a plurality of platforms for broadcasting multimedia content;
a machine-learning model trained to simulate an audience reaction to one or more particular pieces of multimedia content when broadcast by one or more particular platforms for broadcasting multimedia content, and to generate recommendations for the one or more particular pieces of multimedia content to be broadcast by the one or more particular platforms for broadcasting multimedia content, wherein the first database and second database each input information into the machine-learning model.

49. The machine-learning system of claim 48, wherein the first and second databases are housed on a single server.

50. The machine-learning system of claim 48, wherein the machine-learning model is housed on a server configured for parallel processing.

51. The machine-learning system of claim 48, wherein the machine-learning model is a neural network.

52. The machine-learning system of claim 51, wherein the neural network is a Long Short-Term Memory (LSTM) neural network or a Deep Convolutional Neural Network.

53. The machine-learning system of claim 48, further comprising an Internet portal site and application programming interface (API) for entering information to be input into the first database.

54. The machine-learning system of claim 48, further comprising one or more social media application programming interfaces (APIs), demographic data services, and chat applications for inputting information into the second database.

55-80. (canceled)
